(19) United States
(12) Patent Application Publication
(10) Pub. No.: US 2026/0341231 A1
(43) Pub. Date: Oct. 29, 2026

(54) DISPLAY PANEL AND DISPLAY APPARATUS

(71) Applicant: XIAMEN TIANMA DISPLAY TECHNOLOGY CO., LTD., Xiamen (CN)

(72) Inventors: Xuehuan FENG, Xiamen (CN); Yana GAO, Xiamen (CN); Xingyao ZHOU, Xiamen (CN)

(21) Appl. No.: 19/707,674

(22) Filed: Jun. 15, 2026

(30) Foreign Application Priority Data
Sep. 25, 2025 (CN) 202511383520.X

(51) Int. Cl. G09G 3/3266; G09G 3/3233

(52) U.S. Cl. CPC G09G 3/3266; G09G 3/3233; G09G 2300/0819; G09G 2300/0842; G09G 2310/0286; G09G 2310/08

(57) ABSTRACT

A display panel includes a driving circuit including shift registers that are cascaded. The shift registers include an x-th stage shift register and a y-th stage shift register. In shift register, a first node control module receive at least input signal and clock signal, and control signal of first node. A second node control module receive signal of first node, and control a signal of a second node. The pull-down control module receive signal of first node, first control signal, and second control signal, and control conducting states of first pull-down module and second pull-down module. The first and second pull-down modules are configured to pull down signal of second node when in conducting state. A conduction duration of first pull-down module does not overlap conduction duration of second pull-down module. The output module receive signal of first node and signal of second node, and output gate driving signal.

### CROSS-REFERENCE TO RELATED APPLICATION

The present application claims priority to Chinese Patent Application No. 202511383520.X, filed on Sep. 25, 2025, the content of which is incorporated herein by reference in its entirety.

### TECHNICAL FIELD

The present disclosure relates to the technical field of displaying and, in particular, to a display panel and a display apparatus.

### BACKGROUND

With the development of display technology, electronic products with display functions are widely used in various fields, such as televisions, mobile phones, computers, and personal digital assistants, becoming an indispensable part of people's life and work. The display panel is a core structure that realizes the display function in electronic products.

A display panel typically includes a pixel array and a driving circuit for driving the pixel array. The driving circuit can scan the pixel array line by line to enable image display. However, due to limitations in the device structure and characteristics of the driving circuit, the signal output of the driving circuit is inaccurate, thereby affecting the display effect of the display panel.

### SUMMARY

An aspect of the present disclosure provides a display panel. The display panel includes a driving circuit. The driving circuit includes cascaded shift registers that are cascaded, the shift registers include an x-th stage shift register and a y-th stage shift register. One of the shift registers includes a first node control module, a second node control module, a pull-down control module, a first pull-down module, a second pull-down module, and an output module. The first node control module is configured to receive at least an input signal and a clock signal, and to control a signal of a first node. The second node control module is configured to receive at least the signal of the first node, and control a signal of a second node. The pull-down control module is configured to receive at least the signal of the first node, a first control signal, and a second control signal, and to control conducting states of the first pull-down module and the second pull-down module. The first pull-down module and the second pull-down module are each configured to pull down the signal of the second node when in a conducting state, and a conducting duration of the first pull-down module does not overlap with a conducting duration of the second pull-down module. The output module is configured to receive at least the signal of the first node and the signal of the second node, and output a gate driving signal. A gate driving signal output by the x-th stage shift register is an input signal of the y-th stage shift register, where x≠y, and x and y are positive integers.

Another aspect of the present disclosure provides a display apparatus including a display panel. The display panel includes a driving circuit. The driving circuit includes shift registers that are cascaded, the shift registers comprise an x-th stage shift register and a y-th stage shift register. One of the shift registers includes a first node control module, a second node control module, a pull-down control module, a first pull-down module, a second pull-down module, and an output module. The first node control module is configured to receive at least an input signal and a clock signal, and to control a signal of a first node. The second node control module is configured to receive at least the signal of the first node, and to control a signal of a second node. The pull-down control module is configured to receive at least the signal of the first node, a first control signal, and a second control signal, and to control conducting states of the first pull-down module and the second pull-down module. The first pull-down module and the second pull-down module are each configured to pull down the signal of the second node when in a conducting state, and a conducting duration of the first pull-down module does not overlap with a conducting duration of the second pull-down module. The output module is configured to receive at least the signal of the first node and the signal of the second node, and output a gate driving signal. A gate driving signal output by the x-th stage shift register is an input signal of the y-th stage shift register, where x≠y, and x and y are positive integers.

### BRIEF DESCRIPTION OF DRAWINGS

FIG. 1 is a structural schematic diagram of a display panel according to an embodiment of the present disclosure;

FIG. 2 is a structural schematic diagram of a shift register according to an embodiment of the present disclosure;

FIG. 3 is a structural schematic diagram of a driving circuit according to an embodiment of the present disclosure;

FIG. 4 is a structural schematic diagram of a further driving circuit according to an embodiment of the present disclosure;

FIG. 5 is a structural schematic diagram of a further shift register according to an embodiment of the present disclosure;

FIG. 6 is a structural schematic diagram of a further shift register according to an embodiment of the present disclosure;

FIG. 7 is a structural schematic diagram of a further shift register according to an embodiment of the present disclosure;

FIG. 8 is a structural schematic diagram of a further shift register according to an embodiment of the present disclosure;

FIG. 9 is a structural schematic diagram of a further shift register according to an embodiment of the present disclosure;

FIG. 10 is a structural schematic diagram of a further shift register according to an embodiment of the present disclosure;

FIG. 11 is a structural schematic diagram of a further shift register according to an embodiment of the present disclosure;

FIG. 12 is a structural schematic diagram of a further shift register according to an embodiment of the present disclosure;

FIG. 13 is a structural schematic diagram of a further shift register according to an embodiment of the present disclosure;

FIG. 14 is a structural schematic diagram of a further shift register according to an embodiment of the present disclosure;

FIG. 15 is a structural schematic diagram of a further shift register according to an embodiment of the present disclosure;

FIG. 16 is a structural schematic diagram of a further shift register according to an embodiment of the present disclosure;

FIG. 17 is a structural schematic diagram of a further shift register according to an embodiment of the present disclosure;

FIG. 18 is a structural schematic diagram of a further shift register according to an embodiment of the present disclosure;

FIG. 19 is a structural schematic diagram of a further shift register according to an embodiment of the present disclosure;

FIG. 20 is a structural schematic diagram of a further shift register according to an embodiment of the present disclosure;

FIG. 21 is a structural schematic diagram of a further shift register according to an embodiment of the present disclosure;

FIG. 22 is a structural schematic diagram of a further shift register according to an embodiment of the present disclosure;

FIG. 23 is a structural schematic diagram of a further shift register according to an embodiment of the present disclosure;

FIG. 24 is a structural schematic diagram of a further shift register according to an embodiment of the present disclosure;

FIG. 25 is a structural schematic diagram of a further shift register according to an embodiment of the present disclosure;

FIG. 26 is a timing diagram of a control signal according to an embodiment of the present disclosure;

FIG. 27 is a timing diagram of a further control signal according to an embodiment of the present disclosure;

FIG. 28 is a timing diagram of a further control signal according to an embodiment of the present disclosure;

FIG. 29 is a driving timing diagram of a shift register according to an embodiment of the present disclosure;

FIG. 30 is a driving timing diagram of a display panel according to an embodiment of the present disclosure;

FIG. 31 is a structural schematic diagram of a pixel circuit according to an embodiment of the present disclosure;

FIG. 32 is a structural schematic diagram of a further display panel according to an embodiment of the present disclosure;

FIG. 33 is a driving timing diagram of a further display panel according to an embodiment of the present disclosure; and

FIG. 34 is a structural schematic diagram of a display apparatus according to an embodiment of the present disclosure.

### DESCRIPTION OF EMBODIMENTS

The present disclosure will be further described in detail with reference to the drawings and embodiments. It should be understood that the embodiments described herein are merely illustrative of the present disclosure and not intended to limit it. Furthermore, it should be noted that, for ease of description, only the parts relevant to the present disclosure, rather than the entire structure, are shown in the drawings.

As described in the background, a display panel includes a plurality of pixel circuits and driving circuits arranged in an array. The driving circuit may include cascaded shift registers with multiple stages. The shift registers at each stage sequentially output the valid levels of the gate driving signals, so as to sequentially control conduction of the corresponding transistors in each row of the pixel circuits, and to sequentially control the writing of the pixel data signals in each row, so that the pixel circuits can display and emit light according to the data signals written thereto.

During the display time of a frame, the duration of the valid level of the gate driving signal output by the shift register is usually short, causing the gate driving signal output by the shift register to remain at an invalid level for a long time. The device, such as a transistor, configured to control the invalid level of the gate driving signal output by the shift register needs to remain conductive for a long time, so that the transistor remains biased for a long time, resulting in a drift in its threshold voltage. This drift makes it difficult to accurately switch the state of the transistor, thereby reducing the accuracy of the gate driving signal output by the shift register, which in turn reduces the accuracy of writing the data signal into the pixel circuit, and is thus unfavorable for improving the display effect of the display panel.

To address the above technical problems, embodiments of the present disclosure provide a display panel, including a driving circuit. The driving circuit includes shift registers that are cascaded. The shift registers includes a first node control module, a second node control module, a pull-down control module, a first pull-down module, a second pull-down module, and an output module. The first node control module is configured to receive at least an input signal and a clock signal, and control a signal of a first node. The second node control module is configured to receive at least the signal of the first node, and control a signal of the second node. The pull-down control module is configured to receive at least the signal of the first node, a first control signal, and a second control signal, and control conducting states of the first pull-down module and the second pull-down module. The first pull-down module and the second pull-down module are each configured to pull down the signal of the second node when in a conducting state. A conducting duration of the first pull-down module does not overlap with a conducting duration of the second pull-down module. The output module is configured to receive at least the signal of the first node and the signal of the second node, and output a gate driving signal. The gate driving signal output by an x-th stage shift register serves as an input signal of a y-th stage shift register, where x≠y, and x and y are positive integers.

In the above technical solution, by providing the pull-down control module, the first pull-down module, and the second pull-down module in the shift register, the pull-down control module can control the conducting state of the first and second pull-down modules based on the signal of the first node, the first control signal, and the second control signal received thereby. Furthermore, the conducting duration of the first pull-down module does not overlap with the conducting duration of the second pull-down module, allowing the first and second pull-down modules to pull down the signal of the second node at different times. Compared to the case where the pull-down modules continuously conduct to pull down the signal of the second node, the first pull-down module and the second pull-down module conduct at different times, which can delay device aging in the first and second pull-down modules, mitigate threshold drift issues of devices in the first and second pull-down modules, and improve the accuracy of the pull-down control module in controlling the first and second pull-down modules. Such a design is favorable for improving the accuracy of the first and second pull-down modules in pulling down the signal of the second node, and is further favorable for improving the accuracy of the gate driving signal output by the shift register when the output module outputs the gate driving signal based on the signal of the first node and signal of the second node, thereby improving the display effect of the display panel including the shift register.

The above is the core idea of the present disclosure. Based on the embodiments of the present disclosure, all other embodiments obtained by those skilled in the art without creative effort shall fall within the protection scope of the present disclosure. The technical solutions in the embodiments of the present disclosure will be clearly and completely described below with reference to the drawings.

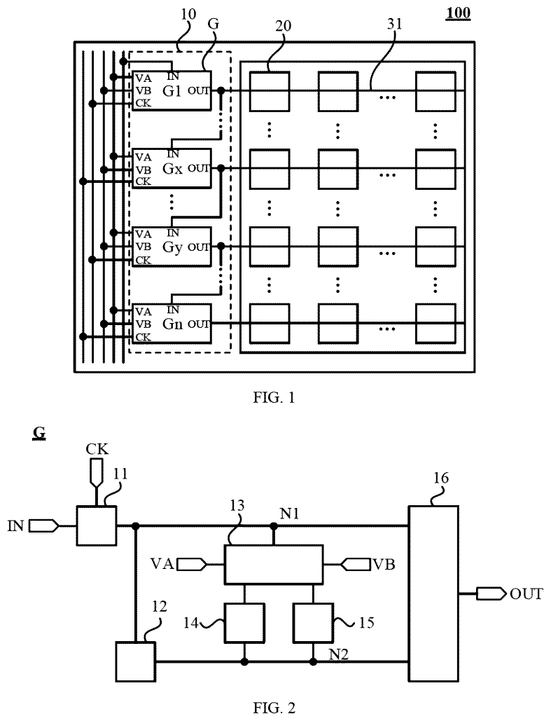

FIG. 1 is a structural schematic diagram of a display panel according to an embodiment of the present disclosure, and FIG. 2 is a structural schematic diagram of a shift register according to an embodiment of the present disclosure. Referring to FIG. 1 and FIG. 2, a display panel 100 includes a driving circuit 10, and the driving circuit 10 includes a plurality of stages of shift registers G arranged in a cascaded manner. The shift register G includes a first node control module 11, a second node control module 12, a pull-down control module 13, a first pull-down module 14, a second pull-down module 15, and an output module 16. The first node control module 11 is configured to receive at least an input signal Vin and a clock signal Ck, and control a signal VN1 of a first node N1. The second node control module 12 is configured to receive at least the signal VN1 of the first node N1 and control a signal VN2 of a second node N2. The pull-down control module 13 is configured to receive at least the signal VN1 of the first node N1, a first control signal Va, and a second control signal Vb, and control conducting states of the first pull-down module 14 and the second pull-down module 15. The first pull-down module 14 and the second pull-down module 15 are each configured to pull down the signal of the second node N2 when in a conducting state. A conducting duration of the first pull-down module 14 does not overlap with a conducting duration of the second pull-down module 15. The output module 16 is configured to receive at least the signal VN1 of the first node N1 and the signal VN2 of the second node N2, and output a gate driving signal Gout. A gate driving signal Goutx output by an x-th stage shift register Gx serves as an input signal Vinx of a y-th stage shift register Gy, where x≠y, and x and y are positive integers.

It is understood that the clock signal Ck may include high and low levels that vary with a certain clock cycle. An active pulse of the clock signal Ck may be at a high level or a low level and may be designed according to actual needs, which is not limited in the embodiments of the present disclosure. For ease of description, unless otherwise specified, the embodiments of the present disclosure exemplarily illustrate the technical solutions using the case where the active pulse of the clock signal Ck is at low level. During the operation of the display panel 100, both the first control signal Va and the second control signal Vb may include high and low levels. One of the high and low levels is the valid level of the first control signal Va and the second control signal Vb, and the other is the invalid level of the first control signal Va and the second control signal Vb. The valid levels of the first control signal Va and the second control signal Vb may be the same or different. In an embodiment, the valid levels of the first control signal Va and the second control signal Vb may both be high level or low level, In an embodiment, one of valid levels of the first control signal Va and the second control signal Vb may be high level, and the other may be low level, which can be designed according to actual needs, and is not limited in the embodiments of the present disclosure.

It is also understood that the valid and invalid levels of the signal are related to the device it controls. In an embodiment, for a signal controlling a P-type transistor, the valid level is low level and the invalid level is high level. For a signal controlling an N-type transistor, the valid level is high level and the invalid level is low level. Therefore, in some the embodiments of the present disclosure, the valid levels of each signal can be the same or different, and can be designed according to the device controlled by each signal, which is not limited in the embodiments of the present disclosure.

In the shift register G, the first node control module 11 receives at least the input signal Vin and the clock signal Ck, and controls the signal VN1 of the first node N1. The shift register G may also include at least a signal input terminal IN and a clock terminal CK. The first node control module 11 may be electrically connected to the signal input terminal IN, the clock terminal CK and the first node N1, respectively, so that the first node control module 11 can receive the input signal Vin of the signal input terminal IN and the clock signal Ck of the clock terminal CK, thereby realizing the control of the signal VN1 of the first node N1 under the control of the input signal Vin of the signal input terminal IN and the clock signal of the clock terminal CK. In an embodiment, when the clock signal Ck of the clock terminal CK is an active pulse, the first node control module 11 can control the input signal Vin of the signal input terminal IN to be transmitted to the first node N1, so that the signal of the first node N1 can be consistent with the input signal Vin. However, when the clock signal Ck of the clock terminal CK is at an invalid level, the first node control module 11 cannot transmit the input signal of the signal input terminal IN to the first node N1.

The second node control module 12 receives at least the signal VN1 of the first node N1 and controls the signal VN2 of the second node N2. The second node control module 12 is electrically connected to at least the first node N1 and the second node N2, respectively, allowing the signal VN1 of the first node N1 to control the signal provided by the second node control module 12 to the second node N2, thereby realizing control of the signal VN2 of the second node N2. In an embodiment, when the signal of the first node N1 is at a valid level that controls the second node control module 12, the second node control module 12 may control the signal VN2 of the second node N2 to be at an invalid level. Conversely, the second node control module 12 cannot control the signal of the second node N2, allowing the signal of the second node N2 to be controlled by other modules. Thus, it is possible to ensure that the signals of the first node N1 and the second node N2 have different polarities for at least a portion of the time the display panel 100 is operating. In an embodiment, when the signal of the first node N1 is at a low level, the signal of the second node N2 may be at a high level.

The pull-down control module 13 receives at least the signal VN1 of the first node N1, the first control signal Va, and the second control signal Vb, and controls the first pull-down module 14 and the second pull-down module 15. The shift register G may also include a first control terminal VA and a second control terminal VB. The pull-down control module 13 can be electrically connected to the first node N1, the first control terminal VA, the second control terminal VB, the first pull-down module 14, and the second pull-down module 15, respectively, so that the pull-down control module 13 can control the state of the first pull-down module 14 and the second pull-down module 15 under the control of the signal of the first node N1, the first control signal Va of the first control terminal VA, and the second control signal Vb of the second control terminal VB, thereby causing the first pull-down module 14 and the second pull-down module 15 to be in a conducting or non-conducting state. In an embodiment, when the signal VN1 of the first node N1 is at an invalid level and the first control signal Va is at a valid level, the first pull-down module 14 can be controlled to be in a conducting state. When the signal VN1 of the first node N1 is at a valid level, meanwhile/In an embodiment, the first control signal Va is at an invalid level, the first pull-down module 14 can be controlled to be in a non-conducting state. When the signal VN1 of the first node N1 is at an invalid level, and the second control signal Vb is at a valid level, the second pull-down module 15 can be controlled to be in a conducting state. When the signal VN1 of the first node N1 is at a valid level, meanwhile/In an embodiment, the second control signal Vb is at an invalid level, the second pull-down module 15 can be controlled to be in a non-conducting state. Thus, the state of the first pull-down module 14 can be controlled by the first control signal Va combined with the signal VN1 of the first node N1, and the state of the second pull-down module 15 can be controlled by the second control signal Vb combined with the signal VN1 of the first node N1.

When the first pull-down module 14 and the second pull-down module 15 are in a conducting state, the first pull-down module 14 and the second pull-down module 15 can pull down the signal of the second node N2, and the conducting duration of the first pull-down module 14 does not overlap with the conducting duration of the second pull-down module 15. That is, when the first pull-down module 14 is in the conducting state, the second pull-down module 15 is in the non-conducting state. Conversely, when the second pull-down module 15 is in the conducting state, the first pull-down module 14 can be in the non-conducting state. Thus, the states of the first pull-down module 14 and the second pull-down module 15 can be controlled by the first control signal Va and the second control signal Vb, respectively, so that the first pull-down module 14 and the second pull-down module 15 conduct during different time periods. This relatively shortens the time for one of the first pull-down module 14 and the second pull-down module 15 to conduct independently, reduces the bias time of the devices in the first pull-down module 14 and the second pull-down module 15, mitigates failure issue caused by the long bias time of the devices in the first pull-down module 14 and the second pull-down module 15, and is favorable for prolonging the lifespan of the devices in the first pull-down module 14 and the second pull-down module 15. Such a design ensures the accuracy of the first pull-down module 14 and the second pull-down module 15 in pulling down the signal of the second node N2, and is further favorable to prolonging the lifespan of the shift register G and the accuracy of the signal of the second node N2.

The output module 16 receives at least the signal VN1 of the first node N1 and the signal VN2 of the second node N2, and outputs the gate driving signal Gout. The shift register G may also include a signal output terminal OUT. The output module 16 may be electrically connected to the first node N1, the second node N2, and the signal output terminal OUT, respectively, so that the signal VN1 of the first node N1 and the signal VN2 of the second node N2 can control the gate driving signal Gout provided by the output module 16 to the signal output terminal OUT. In an embodiment, when the signal VN1 of the first node N1 is at a valid level, the output module 16 can provide a valid level of the gate driving signal Gout to the signal output terminal OUT under the control of the signal VN1 of the first node N1. When the signal VN2 of the second node N2 is at a valid level, the output module 16 can provide an invalid level of the gate driving signal Gout to the signal output terminal OUT under the control of the signal VN2 of the second node N2. Thus, the signal VN1 of the first node N1 and the signal VN2 of the second node N2 can respectively control the output module 16 to provide the gate driving signal Gout to the signal output terminal OUT. When the accuracy of the signal VN2 of the second node N2 is improved by controlling the conducting duration of the first pull-down module 14 and the second pull-down module 15, the gate driving signal Gout controlled by the second node N2 also has high accuracy, which is favorable for improving the accuracy of the gate driving signal Gout output by the shift register G, and thus improving the display quality of the display panel 100.

Furthermore, referring to FIG. 1 and FIG. 2, the gate driving signal Goutx of the x-th stage shift register Gx can serve as the input signal Viny of the y-th stage shift register Gy. That is, the signal output terminal OUT of the x-th stage shift register Gx can be electrically connected to the signal input terminal IN of the y-th stage shift register Gy. The gate driving signal Goutx of the x-th stage shift register Gx can control the signal provided by the first node control module 11 in the y-th stage shift register Gy to the first node N1 in the y-th stage shift register Gy, so that the gate driving signal Goutx of the x-th stage shift register Gx can be accurately shifted and registered through the y-th stage shift register Gy.

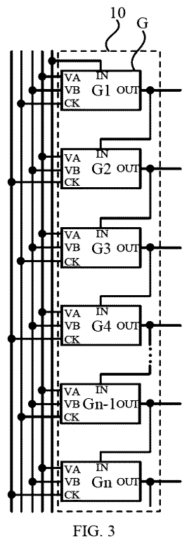

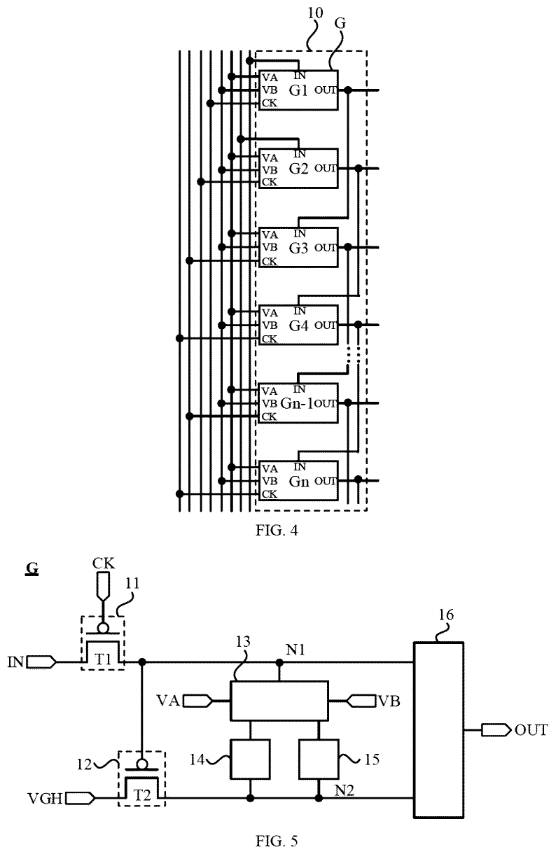

It is understood that the driving circuit 10 may include a plurality of stages of shift registers G. In an embodiment, the driving circuit 10 may include n stages of shift registers G, namely the first stage shift register G1 to the n-th stage shift register Gn, where n can be a positive integer greater than or equal to 2, and x and y are both less than or equal to n, which can be set according to actual needs, and is not limited in the embodiments of the present disclosure. The inequality x≠y indicates that x can be greater than y or less than y. In an embodiment, as shown in FIG. 3, when the x-th stage shift register Gx and the y-th stage shift register Gy are two adjacent shift registers, if x is equal to i, then y can be equal to i+1. In an embodiment, as shown in FIG. 4, the x-th stage shift register Gx and the y-th stage shift register Gy can also be two non-adjacent shift registers, where x and y can be positive integers greater than or equal to 2. On the premise that the core inventive points of the embodiments of the present disclosure can be realized, the values of x and y are not limited in the embodiments of the present disclosure. For ease of description, unless otherwise specified, the embodiments of the present disclosure exemplarily illustrate the technical solutions using the case where y-x is equal to 1.

In an embodiment, by providing the pull-down control module, the first pull-down module, and the second pull-down mode in the shift register, the pull-down control module can control the conducting state of the first and second pull-down modules based on the signal of the first node, the first control signal, and the second control signal received thereby. Furthermore, the conducting duration of the first pull-down module does not overlap with the conducting duration of the second pull-down module, allowing the first and second pull-down modules to pull down the signal of the second node at different times. Compared to the case where the pull-down modules continuously conduct to pull down the signal of the second node, the first pull-down module and the second pull-down module conduct at different times, which can delay device aging in the first and second pull-down modules, mitigate threshold drift issues of devices in the first and second pull-down modules, and improve the accuracy of the pull-down control module in controlling the first and second pull-down modules. Such a design is favorable for improving the accuracy of the first and second pull-down modules in pulling down the signal of the second node, and is further favorable for improving the accuracy of the gate driving signal output by the shift register when the output module outputs the gate driving signal based on the signal of the first node and signal of the second node, thereby improving the display effect of the display panel including the shift register.

It should be noted that the above description merely provides exemplary explanations of the structure and operation of the shift register. On the premise that the core inventive points of the embodiments of the present disclosure can be realized, the embodiments of the present disclosure do not make specific limitations in this regard. To more clearly explain the embodiments of the present disclosure, typical examples of the shift register G are illustratively described below.

FIG. 5 is a structural schematic diagram of a further shift register according to an embodiment of the present disclosure. Referring to FIG. 5, the first node control module 11 includes a first node control transistor T1. A gate of the first node control transistor T1 receives the clock signal Ck, a first electrode of the first node control transistor T1 receives the input signal Vin, and a second electrode of the first node control transistor T1 is electrically connected to the first node N1. Thus, the clock signal Ck can control the first node control transistor T1 to be turned on or off, and when the clock signal Ck controls the first node control transistor T1 to be turned on, the first node control transistor T1 can transmit the input signal Vin to the first node N1, so that the signal VN1 of the first node N1 can be consistent with the input signal Vin. That is, when the input signal Vin is at a high level, the signal VN1 of the first node N1 can be at a high level, and conversely, when the input signal Vin is at a low level, the signal VN1 of the first node N1 can also be at a low level.

In an embodiment, the first node control transistor T1 may be an N-type transistor or a P-type transistor, which can be designed according to actual needs, and is not limited in the embodiments of the present disclosure. In an embodiment, the first node control transistor T1 may be a P-type transistor, and an active layer material of the first node control transistor T1 may include low-temperature polycrystalline silicon material, so that the first node control transistor T1 has a high mobility, thereby improving the signal transmission accuracy of the first node N1 and further improving the accuracy of the signal VN1 of the first node N1.

In some embodiments, the second node control module 12 includes a second node control transistor T2. A gate of the second node control transistor T2 is electrically connected to the first node N1, a first electrode of the second node control transistor T2 receives a second level signal Vgh, and a second electrode of the second node control transistor T2 is electrically connected to the second node N2. Thus, the signal VN1 of the first node N1 can control the second node control transistor T2 to be turned on or off. When the signal VN1 of the first node N1 controls the second node control transistor T2 to be turned on, the second node control transistor T2 can transmit the second level signal Vgh to the second node N2, so that the signal VN2 of the second node N2 can be consistent with the second level signal Vgh. That is, when the second level signal Vgh is at a high level, the signal VN2 of the second node N2 can be at a high level, and conversely, when the second level signal Vgh is at a low level, the signal VN2 of the second node N2 can also be at a low level.

In an embodiment, the second node control transistor T2 may be an N-type transistor or a P-type transistor, which can be designed according to actual needs, and is not limited in the embodiments of the present disclosure. In an embodiment, the second node control transistor T2 may be a P-type transistor, so that the second node control transistor T2 has a high mobility, thereby improving the signal transmission accuracy of the second node control transistor T2 and further improving the accuracy of the signal VN2 of the second node N2.

It is understood that when the first electrode of the second node control transistor T2 receives the second level signal Vgh, the shift register G may further include a second level terminal VGH. The second level terminal VGH may be configured to provide the second level signal Vgh. The second level signal Vgh may be a fixed level signal. That is, during the operation of the display panel, the second level signal Vgh may be at a continuous high level or low level. On the premise of realizing the control of the signal VN2 of the second node N2, the embodiments of the present disclosure do not make specific limitations in this regard.

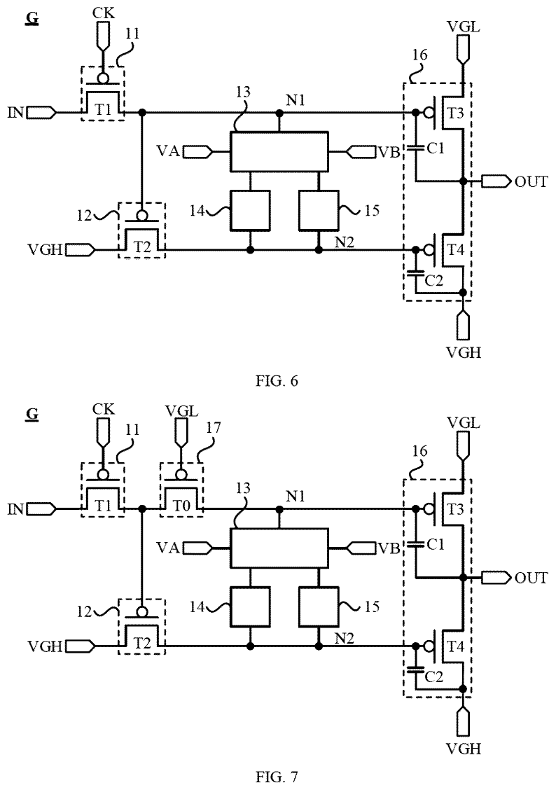

In some embodiments, FIG. 6 is a structural schematic diagram of a further shift register according to an embodiment of the present disclosure. Referring to FIG. 6, the output module 16 includes a first output transistor T3 and a second output transistor T4. A gate of the first output transistor T3 is electrically connected to the first node N1, a first electrode of the first output transistor T3 receives a first level signal Vgl, and a second electrode of the first output transistor T3 is configured to output the gate driving signal Gout. A gate of the second output transistor T4 is electrically connected to the second node N2, a first electrode of the second output transistor T4 receives a second level signal Vgh, and a second electrode of the second output transistor T4 is configured to output the gate driving signal Gout.

Since the first electrode of the first output transistor T3 receives the first level signal Vgl, and the first electrode of the second output transistor T4 receives the second level signal Vgh, the shift register G can further include a first level terminal VGL and a second level terminal VGH, so that the first electrode of the first output transistor T3 can be electrically connected to the first level terminal VGL to receive the first level signal Vgl of the first level terminal VGL, and the first electrode of the second output transistor T4 can be electrically connected to the second level terminal VGH to receive the second level signal Vgh of the second level terminal VGH. The second electrode of the first output transistor T3 and the second electrode of the second output transistor T4 can both be electrically connected to the signal output terminal OUT.

The signal VN1 of the first node N1 can control the first output transistor T3 to be turned on or off. When signal VN1 of the first node N1 controls the first output transistor T3 to be turned on, the first level signal Vgl can be transmitted to the signal output terminal OUT, so that the gate driving signal Gout output by the signal output terminal OUT can be consistent with the first level signal Vgl. The signal VN2 of the second node N2 can control the second output transistor T4 to be turned on or off. When signal VN2 of the second node N2 controls the second output transistor T4 to be turned on, the second level signal Vgh can be transmitted to the signal output terminal OUT, so that the gate driving signal Gout output by the signal output terminal OUT can be consistent with the second level signal Vgh. Thus, by ensuring that the conducting duration of the first output transistor T3 controlled by the signal VN1 of the first node N1 does not overlap with the conducting duration of the second output transistor T4 controlled by the signal VN2 of the second node N2, the signal output terminal OUT can output the first level signal Vgl and the second level signal Vgh in a time-division manner.

It is understood that the first level signal Vgl and the second level signal Vgh can both be fixed level signals, and the first level signal Vgl and the second level signal Vgh can have different polarities. That is, when the first level signal Vgl is at a low level, the second level signal Vgh is at a high level, and vice versa. One of the first level signal Vgl and the second level signal Vgh can be consistent with the polarity of the valid level of the gate driving signal Gout, and the other can be consistent with the polarity of the invalid level of the gate driving signal Gout. For ease of description, unless otherwise specified, the embodiments of the present disclosure exemplarily illustrate the technical solutions using the case where the polarity of the first level signal Vgl is consistent with the polarity of the valid level of the gate driving signal Gout, and the polarity of the second level signal Vgh is consistent with the polarity of the invalid level of the gate driving signal Gout.

It should be noted that the types of the first output transistor T3 and the second output transistor T4 can be of the same or different, which can be designed according to actual needs. Taking an example in which the first output transistor T3 and the second output transistor T4 are of the same type, that is, both the first output transistor T3 and the second output transistor T4 can be N-type transistors or P-type transistors, the polarities of the signal VN1 of the first node N1 and the signal VN2 of the second node N2 are opposite at the same time. That is, when the signal VN1 of the first node N1 is at a high level, the signal VN2 of the second node N2 should be at a low level, and when the signal VN1 of the first node N1 is at a low level, the signal VN2 of the second node N2 should be at a high level, so that the first output transistor T3 and the fourth output transistor T4 can conduct in a time-division manner, and the gate driving signal Gout of the signal output terminal OUT can be at a high level or low level. Thus, the first node control module 11, the second node control module 12, the pull-down control module 13, the first pull-down module 14, and the second pull-down module 15 need to work together to ensure that the signal VN1 of the first node N1 and the signal VN2 of the second node N2 have opposite polarities.

In some embodiments, referring to FIG. 6, the output module 16 may further include a bootstrap capacitor C1, and the bootstrap capacitor C1 can be electrically connected between the first node N1 and the signal output terminal OUT. The bootstrap capacitor C1 can raise or lower the signal of the first node N1 when the gate driving signal Gout of the signal output terminal OUT changes, so that the signal of the first node N1 can change with the gate driving signal Gout of the signal output terminal OUT, and the signal of the first node N1 can accurately control the first output transistor T3 to be turned on or off, thereby improving the accuracy of the gate driving signal Gout of the signal output terminal OUT.

In some embodiments, referring to FIG. 6, the output module 16 may further include a holding capacitor C2, and the holding capacitor C2 can be electrically connected between the second node N2 and a fixed signal terminal. The fixed signal terminal can reuse the first level terminal VGL or the second level terminal VGH. In an embodiment, the fixed signal terminal electrically connected to the holding capacitor C2 can reuse the second level terminal VGH, so that the second output transistor T4 and the holding capacitor C2, both electrically connected to the second node N2, can be connected to the same second level terminal VGH, thereby simplifying the circuit structure of the shift register G and reducing the size of the shift register G. When the shift register G is provided in the bezel area of the display panel, reducing the size of the shift register G is favorable for a narrow bezel design. The holding capacitor C2 is configured to maintain the signal VN2 of the second node N2, so that the signal of the second node N2 can accurately control the second output transistor T4 to be turned on or off, thereby improving the accuracy of the gate driving signal Gout output by the shift register G.

Based on the above embodiments, FIG. 7 is a structural schematic diagram of a further shift register according to an embodiment of the present disclosure, and FIG. 8 is a structural schematic diagram of a further shift register according to an embodiment of the present disclosure. Referring to FIG. 7 and FIG. 8, the shift register G further includes a voltage regulator module 17. The voltage regulator module 17 is electrically connected between the first node control module 11 and the output module 16. At least one of the second node control module 12 and the pull-down control module 13 is electrically connected to the first node N1 through the voltage regulator module 17.

When the first node control module 11 includes the first node control transistor T1 and the output module 16 includes the first output transistor T3, the voltage regulator module 17 can be electrically connected to the second electrode of the first node control transistor T1 and the gate of the first output transistor T3, respectively. The voltage regulator module 17 can stabilize the signals of the second electrode of the first node control transistor T1 and the gate of the first output transistor T3, preventing the normal operation of the first output transistor T3 from being affected by the signal of the second electrode of the first node control transistor T1 exceeding the corresponding threshold range, or preventing the normal operation of the first node control transistor T1 from being affected by the signal of the gate of the first output transistor T3 exceeding the corresponding threshold range. Such a design ensures that the signal of the first node N1 accurately controls the first output transistor T21 to be turned on or off, thereby improving the accuracy of the gate driving signal Gout output by the signal output terminal OUT.

In an embodiment, the voltage regulator module 17 may include a Voltage regulator transistor T0. A gate of the voltage regulator transistor T0 can receive a fixed signal, a first electrode of the voltage regulator transistor T0 can be electrically connected to the first node control module 11, and a second electrode of the voltage regulator transistor T0 can be electrically connected to the output module 16. When the signals of the first node control module 11 and the output module 16 are within normal threshold ranges, the fixed signal received by the gate of the voltage regulator transistor T0 can control the voltage regulator transistor T0 to be in a normal conducting state, and the signal of the first node control module 11 can be consistent with the signal of the output module 16. Conversely, the voltage regulator transistor T0 cannot be controlled to be in the conducting state. Therefore, when one of the signals of the first node control module 11 and the output module 16 is in an abnormal range, the first node control module 11 can be disconnected from the output module 16 to stabilize the signal between them.

It is understood that at least one of the second node control module 12 and the pull-down control module 13 is electrically connected to the first node N1 through the voltage regulator module 17. That is, the second node control module 12 is electrically connected to the first node N1 through the voltage regulator module 17, and the pull-down control module 13 is directly electrically connected to the first node N1. In an embodiment, the pull-down control module 13 is electrically connected to the first node N1 through the voltage regulator module 17, and the second node control module 12 is directly electrically connected to the first node N1. In an embodiment, both the second node control module 12 and the pull-down control module 13 are electrically connected to the first node N1 through the voltage regulator module 17. This setting is favorable for reducing the load of modules directly connected to the first node N1, improving the driving capability of the first node N1, and ensuring that the first node N1 can accurately control the output module 16 to output the corresponding gate driving signal Gout, thereby improving the accuracy of the gate driving signal Gout, and further improving the display quality of the display panel when using the gate driving signal Gout to perform line-by-line scanning.

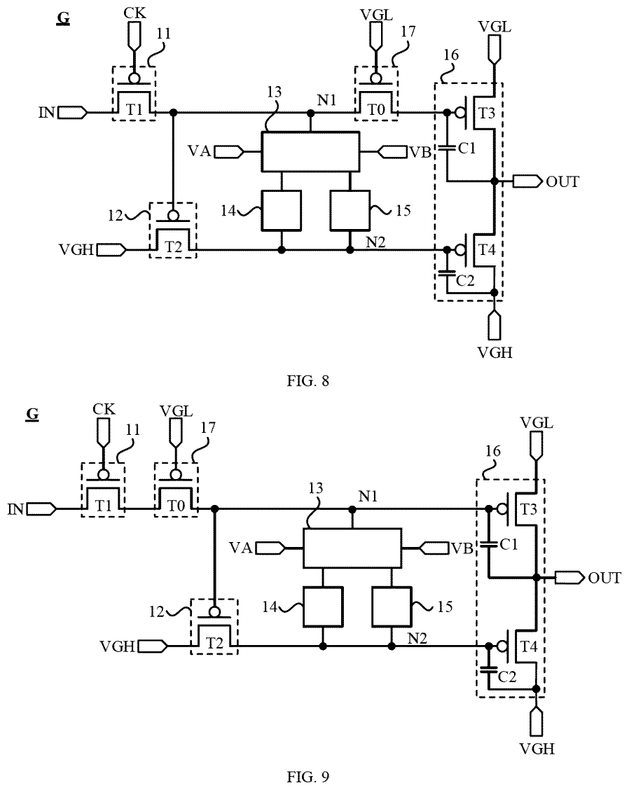

In some embodiments, referring to FIG. 9, when the shift register G includes a voltage regulator module 17, the voltage regulator module 17 can also be electrically connected between the first node control module 11 and the first node N1, so that the voltage regulator module 17 can stabilize the signal of the first node control module 11 and the signal VN1 at the first node N1. The second node control module 12 and the pull-down control module 13 can both be directly electrically connected to the first node N1.

It should be noted that the above merely provides an exemplary explanation of the connection between the second node control module 12 and the pull-down control module 13 and the first node N1 when the shift register G includes the voltage regulator module 17. In some embodiments of the present disclosure, provided that it can be determined that the voltage regulator module 17 stabilizes that signal of the node electrically connected thereto, the embodiments of the present disclosure do not make specific limitations in this regard. For ease of description, unless otherwise specified, the embodiments of the present disclosure exemplarily illustrate the technical solutions using the case where the second node control module 12 is electrically connected to the first node N1 through the voltage regulator module 17, and the pull-down control module 13 is directly electrically connected to the first node N1.

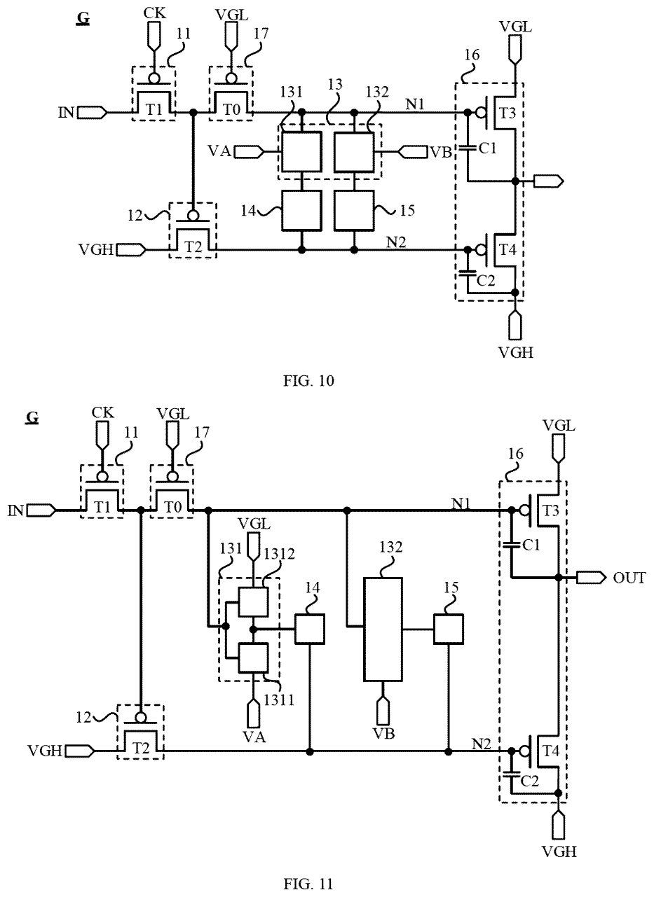

FIG. 10 is a structural schematic diagram of a further shift register according to an embodiment of the present disclosure. Referring to FIG. 10, the pull-down control module 13 includes a first pull-down control sub-module 131 and a second pull-down control sub-module 132. The first pull-down control sub-module 131 is configured to receive at least the first control signal Va and the signal VN1 of the first node N1, and control the conducting state of the first pull-down module 14. The second pull-down control sub-module 132 is configured to receive at least the second control signal Vb and the signal VN1 of the first node N1, and control the conducting state of the second pull-down module 15.

The first pull-down control sub-module 131 can be electrically connected to the first control terminal VA, the first node N1 and the first pull-down module 14, respectively, so that the first pull-down control sub-module 131 can control the first pull-down module 14 to be turned on or off under the control of the first control signal Va of the first control terminal VA and the signal VN1 of the first node N1. In an embodiment, when the signal VN1 of the first node N1 is at an invalid level and the first control signal Va is at a valid level, the first pull-down control sub-module 131 can provide the valid level of the first control signal Va to the first pull-down module 14 to control the first pull-down module 14 to be in the conducting state. When the signal VN1 of the first node N1 is at an invalid level and the first control signal Va is at an invalid level, the first pull-down control sub-module 131 provides the invalid level of the first control signal Va to the first pull-down module 14, so that the first pull-down module 14 is in the non-conducting state. When the signal VN1 of the first node N1 is at a valid level, the first pull-down control sub-module 131 cannot provide the first control signal Va to the first pull-down module 14, so that the first pull-down module 14 is in the non-conducting state. Thus, the signal VN1 of the first node N1 can control whether the first pull-down control sub-module 131 provides the first control signal Va to the first pull-down module 14, thereby controlling the state of the first pull-down module 14.

The second pull-down control sub-module 132 can be electrically connected to the second control terminal VB, the first node N1 and the second pull-down module 15, respectively, so that the second pull-down control sub-module 132 can control the second pull-down module 15 to be turned on or off under the control of the second control signal Vb of the second control terminal VB and the signal VN1 of the first node N1. In an embodiment, when the signal VN1 of the first node N1 is at an invalid level and the second control signal Vb is at a valid level, the second pull-down control sub-module 132 can provide the valid level of the second control signal Vb to the second pull-down module 15 to control the second pull-down module 15 to be in the conducting state. When the signal VN1 of the first node N1 is at an invalid level and the second control signal Vb is at an invalid level, the second pull-down control sub-module 132 provides the invalid level of the second control signal Vb to the second pull-down module 15, so that the second pull-down module 15 is in the non-conducting state. When the signal VN1 of the first node N1 is at a valid level, the second pull-down control sub-module 132 cannot provide the second control signal Vb to the second pull-down module 15, so that the second pull-down module 15 is in the non-conducting state. Thus, the signal VN1 of the first node N1 can control whether the second pull-down control sub-module 132 provides the second control signal Vb to the second pull-down module 15, thereby controlling the state of the second pull-down module 15.

In an embodiment, the first pull-down module 14 can be turned on or off under the control of the first pull-down control sub-module 131, and the second pull-down module 15 can be turned on or off under the control of the second pull-down control sub-module 132, so that the state of the first pull-down module 14 and the state of the second pull-down module 15 do not interfere with each other. Thus, On the premise of ensuring that the conducting duration of the first pull-down module 14 does not overlap with the conducting duration of the second pull-down module 15, the accuracy of the state control of the first pull-down module 14 and the second pull-down module 15 can be improved.

In an embodiment, referring to FIG. 11, the first pull-down control sub-module 131 includes a first turn-on control unit 1311 and a first turn-off control unit 1312. The first turn-on control unit 1311 is configured to provide the first control signal Va to the first pull-down module 14 when the signal VN1 of the first node N1 is at a level that controls the first pull-down module 14 to be turned on. The first turn-off control unit 1312 is configured to provide the first level signal Vgl to the first pull-down module 14 when the signal VN1 of the first node N1 is at a level that controls the first pull-down module 14 to be turned off. The first control signal Va includes a first control signal valid level and a first control signal invalid level. The first control signal valid level is used to control the first pull-down module 14 to be turned on. The first control signal invalid level and the first level signal Vgl are both used to control the first pull-down module 14 to be turned off.

It is understood that one of the valid level of the first control signal and the invalid level of the first control signal is high level, while the other is low level, which can be designed according to actual needs. Furthermore, the invalid level of the first control signal has the same polarity as the first level signal Vgl. That is, when the first level signal Vgl is at a low level, the invalid level of the first control signal is also at a low level. The valid level of the first control signal is high level, and vice versa.

The first turn-on control unit 1311 can be electrically connected to the first control terminal VA and the first node N1, respectively, so that the signal VN1 of the first node N1 can control the state of the first turn-on control unit 1311 to control the signal transmission path between the first control terminal VA and the first pull-down module 14. In an embodiment, when the signal VN1 of the first node N1 is at a level that controls the first pull-down module 14 to be turned on, the signal VN1 of the first node N1 can also control the first turn-on control unit 1311 to be in the conducting state, so that the first control signal Va of the first control terminal VA can be transmitted to the first pull-down module 14 through the first turn-on control unit 1311, and thus the first pull-down module 14 can be turned on or off under the control of the first control signal Va. When the signal VN1 of the first node N1 is at a level that controls the first pull-down module 14 to be turned off, the signal VN1 of the first node N1 also controls the first turn-on control unit 1311 to be in the non-conducting state, so that the first control signal Va of the first control terminal VA cannot be transmitted to the first pull-down module 14, and thus the state of the first pull-down module 14 is controlled by the first turn-off control unit 1312.

The first turn-off control unit 1312 can be electrically connected to the first level terminal VGL and the first node N1, respectively, so that the signal VN1 of the first node N1 can control the state of the first turn-off control unit 1312 to control the signal transmission path between the first level terminal VGL and the first pull-down module 14. In an embodiment, when the signal VN1 of the first node N1 is at a level that controls the first pull-down module 14 to be turned off, the signal VN1 of the first node N1 can control the first turn-off control unit 1312 to be in the conducting state, so that the first level signal Vgl of the first level terminal VGL can be transmitted to the first pull-down module 14, and thus the first pull-down module 14 is turned off under the control of the first level signal Vgl. When the signal VN1 of the first node N1 is at a level that controls the first pull-down module 14 to be turned on, the signal VN1 of the first node N1 can control the first turn-off control unit 1312 to be in the non-conducting state, so that the first level signal Vgl of the first level terminal VGL cannot be transmitted to the first pull-down module 14 through the first turn-off control unit 1312, and thus the state of the first pull-down module 14 is controlled by the first turn-on control unit 1311.

In an embodiment, the first pull-down control sub-module includes the first turn-on control unit and the first turn-off control unit, so that the first turn-on control unit can control the conducting duration of the first pull-down module, and the first turn-off control unit can control the non-conducting duration of the first pull-down module, thereby realizing accurate control of the conduction or non-conduction of the first pull-down module, enabling the first pull-down module to accurately pull down the signal of the second node, and ensuring that the signal of the second node can accurately control the output module to output the corresponding gate driving signal.

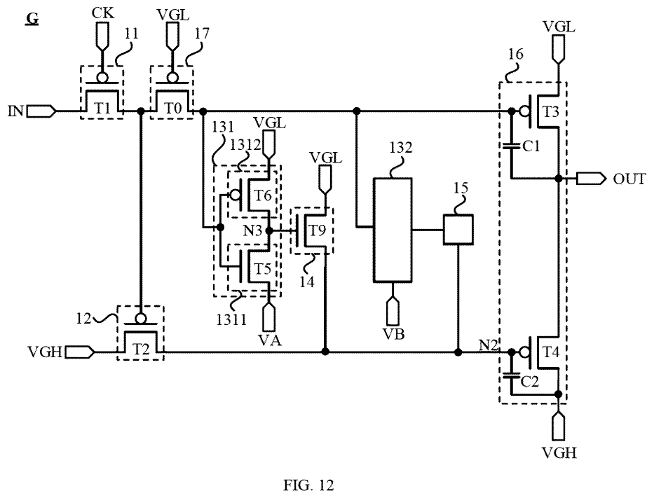

In an embodiment, referring to FIG. 12, the first turn-on control unit 1311 includes a first transistor T5. The first turn-off control unit 1312 includes a second transistor T6. A gate of the first transistor T5 and a gate of the second transistor T6 are both electrically connected to the first node N1. A first electrode of the first transistor T5 receives the first control signal Va, and a first electrode of the second transistor T6 receives the first level signal Vgl. A second electrode of the first transistor T5 and a second electrode of the second transistor T6 are electrically connected to a third node N3. The first pull-down module 14 is electrically connected to the third node N3. The channel type of the first transistor T5 is different from the channel type of the second transistor T6.

It is understood that, since the channel types of the first transistor T5 and the second transistor T6 are different, when the first transistor T5 is an N-type transistor, the second transistor T6 is a P-type transistor. Conversely, when the first transistor T5 is a P-type transistor, the second transistor T6 is a P-type transistor. The types of the first transistor T5 and the second transistor T6 can be designed according to actual needs, and the embodiments of the present disclosure do not make specific limitations in this regard. For ease of description, unless otherwise specified, the embodiments of the present disclosure exemplarily illustrate the technical solutions using the case where the first transistor T5 is an N-type transistor, and the second transistor T6 is a P-type transistor.

The signal VN1 of the first node N1 can respectively control the first transistor T5 and the sixth transistor T6 to conduct in a time-division manner. In an embodiment, when the signal VN1 of the first node N1 is at a high level, the first transistor T5 can be turned on and the second transistor T6 can be turned off, so that the first control signal Va can be transmitted to the third node N3 through the first transistor T5, thereby controlling the first pull-down module 14 electrically connected to the third node N3 to be turned on or off. When the signal VN1 of the first node N1 is at a low level, the first transistor T5 can be turned off and the second transistor T6 can be turned on, so that the first level signal Vgl can be transmitted to the third node N3 through the second transistor T6, thereby controlling the first pull-down module 14 electrically connected to the third node N3 to be in the non-conducting state. Thus, by setting the first transistor T5 and the second transistor T6 to have different channel types, the first control signal Va and the first level signal Vgl can be provided to the first pull-down module 14 in a time-division manner to control the conducting duration of the first pull-down module 14 and ensure that the first pull-down module 14 can accurately pull down the signal of the second node N2.

It should be noted that the above description merely provides an exemplary explanation of the technical solutions of the embodiments of the present disclosure by taking, as an example, the case where both the first turn-on control unit 1311 and the first turn-off control unit 1312 are electrically connected to the first node N1. In some embodiments of the present disclosure, at least one of the first turn-on control unit 1311 and the first turn-off control unit 1312 may not be electrically connected to the first node N1. On the premise that the control of the conduction and non-conduction of the first pull-down module 14 can be achieved, the embodiments of the present disclosure do not make specific limitations in this regard.

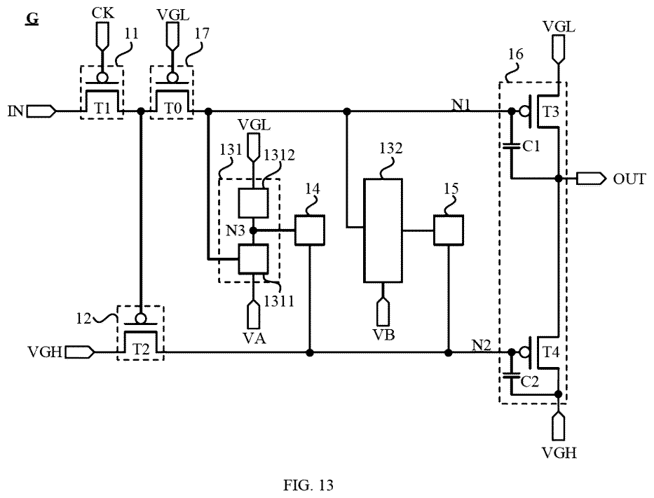

In an embodiment, referring to FIG. 13, the first turn-off control unit 1312 may be electrically connected only to the first level terminal VGL and the first pull-down module 14, and the first turn-on control unit 1311 may be electrically connected to the first control terminal VA, the first node N1 and the first pull-down module 14, respectively, and the first turn-on control unit 1311 and the first turn-off control unit 1312 are electrically connected to the same third node N3 as the first pull-down module 14. When the first turn-on control unit 1311 transmits the first control signal Va to the third node N3 under the control of the signal VN1 of the first node N1, the first turn-off control unit 1312 can be turned on or off under the control of the signal of the third node N3 and the first level signal Vgl. In an embodiment, when the voltage difference between the signal of the third node N3 and the first level signal Vgl meets the turn-on condition of the first turn-off control unit 1312, the first turn-off control unit 1312 can be in the conducting state. When the voltage difference between the signal of the third node N3 and the first level signal Vgl does not meet the turn-on condition of the first turn-off control unit 1312, the first turn-off control unit 1312 can be in the non-conducting state. When the signal VN1 of the first node N1 cannot control the first turn-on control unit 1311 to be turned on, the first control signal Va cannot be transmitted to the third node N3, and the first turn-off control unit 1312 can remain in the conducting state, so that the first level signal Vgl can be transmitted to the third node N3. Thus, by controlling the signal of the third node N3, it is possible to control the conduction or non-conduction of the first pull-down module 14 while controlling the conduction or non-conduction of the first turn-off control unit 1312.

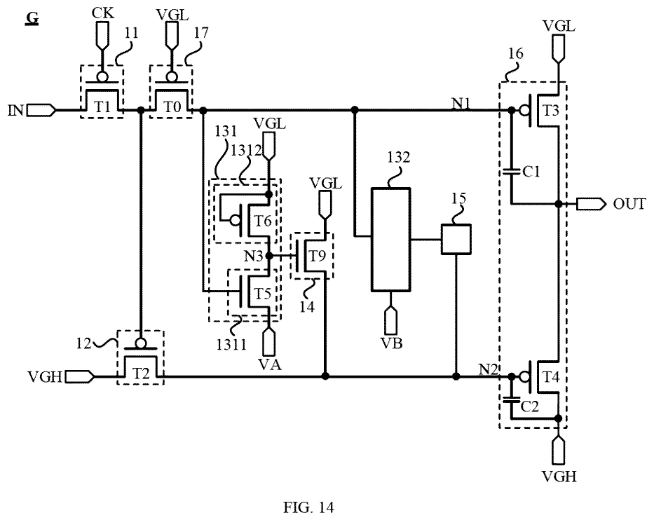

In an embodiment, referring to FIG. 14, when the first turn-on control unit 1311 includes the first transistor T5 and the first turn-off control unit 1312 includes the second transistor T6, the gate of the first transistor T5 is electrically connected to the first node N1, and the first electrode of the first transistor T5 receives the first control signal Va. The gate of the second transistor T6 is electrically connected to the first electrode of the second transistor T6, and the first electrode of the second transistor T6 receives the first level signal Vgl. The second electrode of the second transistor T6 and the second electrode of the first transistor T5 are electrically connected to the third node N3. The first pull-down module 14 is electrically connected to the third node N3.

Since the gate of the first transistor T5 is electrically connected to the first node N1, the signal VN1 of the first node N1 can control the first transistor T5 to be turned on or off. When the signal VN1 of the first node N1 controls the first transistor T5 to be turned on, the first control signal Va can be transmitted to the third node N3, so that the signal of the third node N3 is consistent with the first control signal Va. When the signal of the first node N1 controls the first transistor T5 to be turned off, the first control signal Va cannot be transmitted to the third node N3, and the signal of the third node N3 can be controlled by the signal transmitted by the second transistor T6. Both the first electrode and the gate of the second transistor T6 receive the first level signal Vgl, and the second electrode of the second transistor T6 is electrically connected to the third node N3. The second transistor T6 can be equivalent to a diode, that is, the second transistor T6 can have the characteristics of forward conduction and reverse blocking, so that the second transistor T6 can be turned on or off under the control of the signal of the third node N3 and the first level signal Vgl. In an embodiment, when the second transistor T6 is a P-type transistor, if the voltage difference between the first level signal Vgl and the signal of the third node N3 is greater than the threshold voltage of the second transistor T6, the second transistor T6 can be controlled to be in the conducting state, otherwise, the second transistor T6 is in the non-conducting state. Thus, when the signal of the first node N1 controls the first transistor T5 to be turned on, the first control signal Va transmitted from the first transistor T5 to the third node N3 can be used to control the second transistor T6 to be turned on or off. When the first control signal Va cannot be transmitted to the third node N3, the second transistor T6 can remain in the conducting state, so as to prevent the third node N3 from being in a floating state. This ensures that the signal of the third node N3 can accurately control the first pull-down module 14 to be turned on or off, so that the first pull-down module 14 can accurately pull down the signal VN2 of the second node N2.

It is understood that the channel types of the first transistor T5 and the second transistor T6 can be the same or different, which can be designed according to actual needs, and the embodiments of the present disclosure do not make specific limitations in this regard. In an embodiment, the first transistor T5 and the second transistor T6 can have different channel types. That is, the first transistor T5 is an N-type transistor and the second transistor T6 is a P-type transistor, or the first transistor T5 is a P-type transistor and the second transistor T6 is an N-type transistor, so as to meet the control requirements of the first turn-on control unit 1311 and the first turn-off control unit 1312.

Based on the above embodiments, in some embodiments, when the first transistor T5 is an N-type transistor and the second transistor T6 is a P-type transistor, the channel width-to-length ratio of the first transistor T5 can be greater than the channel width-to-length ratio of the second transistor T6.

The channel width-to-length ratio of the first transistor T5 is greater than that of the second transistor T6, which can be understood as adjusting the channel width and length of the second transistor T6 when the channel width and length of the first transistor T5 remain constant. In an embodiment, the channel width of the second transistor T6 can be decreased and/or the channel length of the second transistor T6 can be increased to decrease the threshold voltage of the second transistor T6 accordingly. Thus, when the signal VN1 of the first node N1 controls the first transistor T5 to be turned on, and the first transistor T5 transmits the first control signal Va to the third node N3, it can be ensured that the first control signal Va provided to the third node N3 can control the second transistor T6 to remain in the non-conducting state, thereby preventing the accuracy of the signal of the third node N3 from being affected by the simultaneous conduction of the first transistor T5 and the second transistor T6.

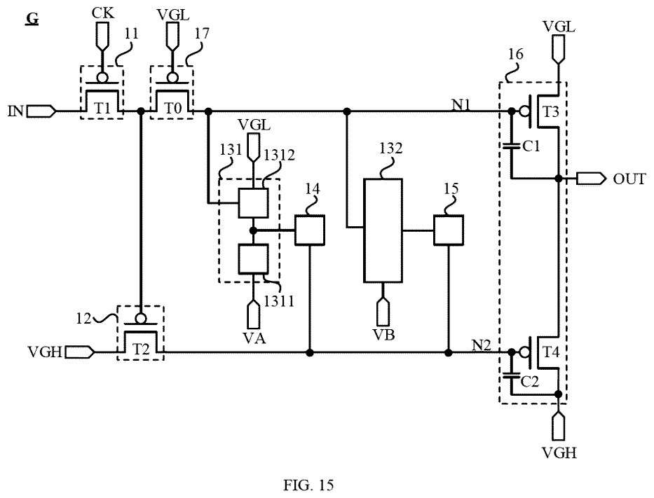

In an embodiment, referring to FIG. 15, the first turn-off control unit 1312 may be electrically connected to the first node N1, the first level terminal VGL and the first pull-down module 14, respectively, and the first turn-on control unit 1311 may be electrically connected only to the first control terminal VA and the first pull-down module 14, and the first turn-on control unit 1311 and the first turn-off control unit 1312 are electrically connected to the same third node N3 as the first pull-down module 14. When the first turn-off control unit 1312 transmits the first level signal Vgl to the third node N3 under the control of the signal VN1 of the first node N1, the first turn-on control unit 1311 can be turned on or off under the control of the signal of the third node N3 and the first control signal Va. In an embodiment, when the voltage difference between the first control signal Va and the signal of the third node N3 meets the turn-on condition of the first turn-on control unit 1311, the first turn-on control unit 1311 can be in the conducting state. When the voltage difference between the first control signal Va and the signal of the third node N3 does not meet the turn-on condition of the first turn-on control unit 1311, the first turn-on control unit 1311 can be in the non-conducting state. When the signal VN1 of the first node N1 cannot control the first turn-off control unit 1312 to be turned on, the first level signal Vgl cannot be transmitted to the third node N3, and the first turn-on control unit 1311 can remain in the conducting state, so that the first control signal Va can be transmitted to the third node N3. Thus, by controlling the signal of the third node N3, it is possible to control the conduction or non-conduction of the first pull-down module 14 while controlling the conduction or non-conduction of the first turn-off control unit 1312.

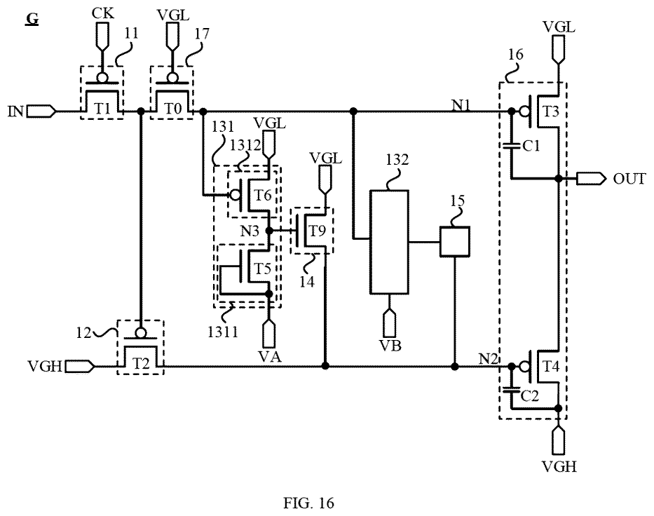

In an embodiment, referring to FIG. 16, when the first turn-on control unit 1311 includes the first transistor T5 and the first turn-off control unit 1312 includes the second transistor T6, the gate of the first transistor T5 is electrically connected to the first electrode of the first transistor T5, and the first electrode of the first transistor T5 receives the first control signal Va. The gate of the second transistor T6 is electrically connected to the first node N1, the first electrode of the second transistor T6 receives the first level signal Vgl, and the second electrode of the second transistor T6 and the second electrode of the first transistor are electrically connected to the third node N3. The first pull-down module 14 is electrically connected to the third node N3.

Since the gate of the second transistor T6 is electrically connected to the first node N1, the signal VN1 of the first node N1 can control the second transistor T6 to be turned on or off. When the signal VN1 of the first node N1 controls the second transistor T6 to be turned on, the first level signal Vgl can be transmitted to the third node N3, so that the signal of the third node N3 is consistent with the first level signal Vgl. When the signal of the first node N1 controls the second transistor T6 to be turned off, the first level signal Vgl cannot be transmitted to the third node N3, and the signal of the third node N3 can be controlled by the signal transmitted by the first transistor T5. Both the first electrode and the gate of the first transistor T5 receive the first control signal Va, and the second electrode of the first transistor T5 is electrically connected to the third node N3. The first transistor T5 can be equivalent to a diode, that is, the first transistor T5 can have the characteristics of forward conduction and reverse blocking, so that the first transistor T5 can be turned on or off under the control of the signal of the third node N3 and the first control signal Va. In an embodiment, when the first transistor T5 is an N-type transistor, if the voltage difference between the first control signal Va and the signal of the third node N3 is greater than the threshold voltage of the first transistor T5, the first transistor T5 can be controlled to be in the conducting state, otherwise, the first transistor T5 is in the non-conducting state. Thus, when the signal of the first node N1 controls the second transistor T6 to be turned on, the first level signal Vgl transmitted from the second transistor T6 to the third node N3 can be used to control the first transistor T5 to be turned on or off. When the first level signal Vgl cannot be transmitted to the third node N3, the first transistor T5 can remain in the conducting state, so as to prevent the third node N3 from being in a floating state. This ensures that the signal of the third node N3 can accurately control the first pull-down module 14 to be turned on or off, so that the first pull-down module 14 can accurately pull down the signal VN2 of the second node N2.

It is understood that the channel types of the first transistor T5 and the second transistor T6 can be the same or different, which can be designed according to actual needs, and the embodiments of the present disclosure do not make specific limitations in this regard. In an embodiment, the first transistor T5 and the second transistor T6 can have different channel types to meet the control requirements of the first turn-on control unit 1311 and the first turn-off control unit 1312.

Based on the above embodiments, in some embodiments, when the first transistor T5 is an N-type transistor and the second transistor T6 is a P-type transistor, the channel width-to-length ratio of the first transistor T5 can be smaller than the channel width-to-length ratio of the second transistor T6.

The channel width-to-length ratio of the first transistor T5 is smaller than that of the second transistor T6, which can be understood as adjusting the channel width and length of the first transistor T5 when the channel width and length of the second transistor T6 remain constant. In an embodiment, the channel width of the first transistor T5 can be decreased and/or the channel length of the first transistor T5 can be increased to decrease the threshold voltage of the first transistor T5 accordingly. Thus, when the signal VN1 of the first node N1 controls the second transistor T6 to be turned on, and the second transistor T6 transmits the first level signal Vgl to the third node N3, it can be ensured that the first level signal Vgl provided to the third node N3 can control the first transistor T5 to remain in the non-conducting state, thereby preventing the accuracy of the signal of the third node N3 from being affected by the simultaneous conduction of the first transistor T5 and the second transistor T6.

It is understood that the above merely provides an exemplary explanation of the structure of the first pull-down control sub-module. In some embodiments of the present disclosure, On the premise that the first pull-down control sub-module can accurately control the first pull-down module to be turned on or off, the specific structure of the first pull-down control sub-module can be designed according to actual needs, and the embodiments of the present disclosure do not make specific limitations in this regard. Correspondingly, the second pull-down control sub-module can have the same or different structure as the first pull-down control sub-module, which can be designed according to actual needs, and the embodiments of the present disclosure do not make specific limitations in this regard either.

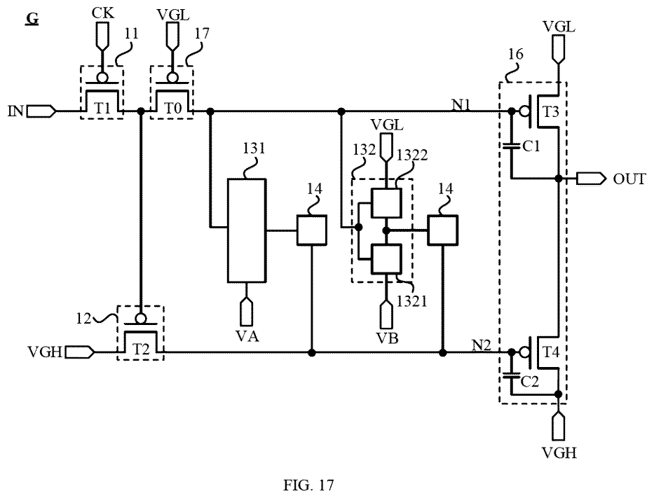

In an embodiment, referring to FIG. 17, the second pull-down control sub-module 132 may include a second turn-on control unit 1321 and a second turn-off control unit 1322. The second turn-on control unit 1321 is configured to provide the second control signal Vb to the second pull-down module 15 when the signal VN1 of the first node N1 is at a level that controls the second pull-down module 15 to be turned on. The second turn-off control unit 1322 is configured to provide the first level signal Vgl to the second pull-down module 15 when the signal of the first node N1 is at a level that controls the second pull-down module 15 to be turned off. The second control signal Vb includes a second control signal valid level and a second control signal invalid level. The second control signal valid level is used to control the second pull-down module 15 to be turned on. The second control signal invalid level and the first level signal Vgl are both used to control the second pull-down module 15 to be turned off.

It is understandable that one of the valid level and invalid level of the second control signal is high level, while the other is low level, which can be designed according to actual needs. Furthermore, the invalid level of the second control signal has the same polarity as the first level signal Vgl. That is, when the first level signal Vgl is at a low level, the invalid level of the second control signal is also at a low level. The valid level of the second control signal is high level, and vice versa.

The second turn-on control unit 1321 can be electrically connected to the second control terminal VB and the first node N1, respectively, so that the signal VN1 of the first node N1 can control the state of the second turn-on control unit 1321 to control the signal transmission path between the second control terminal VB and the second pull-down module 15. In an embodiment, when the signal VN1 of the first node N1 is at a level that controls the second pull-down module 15 to be turned on, the signal VN1 of the first node N1 can also control the second turn-on control unit 1321 to be in the conducting state, so that the second control signal Vb of the second control terminal VB can be transmitted to the second pull-down module 15 through the second turn-on control unit 1321, and thus the second pull-down module 15 can be turned on or off under the control of the second control signal Vb. When the signal VN1 of the first node N1 is at a level that controls the second pull-down module 15 to be turned off, the signal VN1 of the first node N1 also controls the second turn-on control unit 1321 to be in the non-conducting state, so that the second control signal Vb of the second control terminal VB cannot be transmitted to the second pull-down module 15, and thus the state of the second pull-down module 15 is controlled by the second turn-off control unit 1322.

The second turn-off control unit 1322 can be electrically connected to the first level terminal VGL and the first node N1, respectively, so that the signal VN1 of the first node N1 can control the state of the second turn-off control unit 1322 to control the signal transmission path between the first level terminal VGL and the second pull-down module 15. In an embodiment, when the signal VN1 of the first node N1 is at a level that controls the second pull-down module 15 to be turned off, the signal VN1 of the first node N1 can control the second turn-off control unit 1322 to be in a conducting state, so that the first level signal Vgl of the first level terminal VGL can be transmitted to the second pull-down module 15, and thus the second pull-down module 15 is turned off under the control of the first level signal Vgl. When the signal VN1 of the first node N1 is at a level that controls the second pull-down module 15 to be turned on, the signal VN1 of the first node N1 can control the second turn-off control unit 1322 to be in the non-conducting state, so that the first level signal Vgl of the first level terminal VGL cannot be transmitted to the second pull-down module 15 through the second turn-off control unit 1322, and thus the state of the second pull-down module 15 is controlled by the second turn-on control unit 1321.

In an embodiment, the second pull-down control sub-module includes the second turn-on control unit and the second turn-off control unit, the second turn-on control unit can control the conducting duration of the second pull-down module, and the second turn-off control unit can control the non-conducting duration of the second pull-down module, thereby realizing accurate control of the conduction or non-conduction of the second pull-down module, enabling the second pull-down module to accurately pull down the signal of the second node, and ensuring that the signal of the second node can accurately control the output module to output the corresponding gate driving signal.

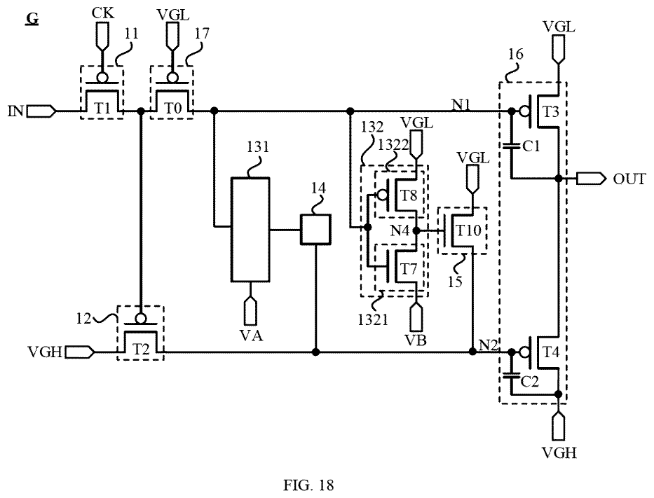

In an embodiment, referring to FIG. 18, the second turn-on control unit 1321 may include a third transistor T7. The second turn-off control unit 1322 may include a fourth transistor T8. A gate of the third transistor T7 and a gate of the fourth transistor T8 are both electrically connected to the first node N1. A first electrode of the third transistor T7 receives the second control signal Vb, and a first electrode of the fourth transistor T8 receives the first level signal Vgl. A second electrode of the third transistor T7 and a second electrode of the fourth transistor T8 are electrically connected to a fourth node N4. The second pull-down module 15 is electrically connected to the fourth node N4. The channel type of the third transistor T7 is different from the channel type of the fourth transistor T8.

It is understood that, since the channel types of the third transistor T7 and the fourth transistor T8 are different, when the third transistor T7 is an N-type transistor, the fourth transistor T8 is a P-type transistor. Conversely, when the third transistor T7 is a P-type transistor, the fourth transistor T8 is an N-type transistor. The types of the third transistor T7 and the fourth transistor T8 can be designed according to actual needs, and the embodiments of the present disclosure do not make specific limitations in this regard. For ease of description, unless otherwise specified, the embodiments of the present disclosure exemplarily illustrate the technical solutions using the case where the third transistor T7 is an N-type transistor, and the fourth transistor T8 is a P-type transistor.

The signal VN1 of the first node N1 can control the third transistor T7 and the fourth transistor T8 to conduct in a time-division manner. In an embodiment, when the signal VN1 of the first node N1 is at a high level, the third transistor T7 can be turned on and the fourth transistor T8 can be turned off, so that the second control signal Vb can be transmitted to the fourth node N4 through the third transistor T7, thereby controlling the second pull-down module 15 electrically connected to the fourth node N4 to be turned on or off. When the signal VN1 of the first node N1 is at a low level, the third transistor T7 can be turned off and the fourth transistor T8 can be turned on, so that the first level signal Vgl can be transmitted to the fourth node N4 through the fourth transistor T8, thereby controlling the second pull-down module 15 electrically connected to the fourth node N4 to be in the non-conducting state. Thus, by setting the third transistor T7 and the fourth transistor T8 to have different channel types, the second control signal Vb and the first level signal Vgl can be provided to the second pull-down module 15 in a time-division manner to control the conducting duration of the second pull-down module 15 and ensure that the second pull-down module 15 can accurately pull down the signal of the second node N2.

It should be noted that the above description merely provides an exemplary explanation of the technical solutions of the embodiments of the present disclosure by taking, as an example, the case where both the second turn-on control unit 1321 and the second turn-off control unit 1322 are electrically connected to the first node N1. In some embodiments of the present disclosure, at least one of the second turn-on control unit 1321 and the second turn-off control unit 1322 may not be electrically connected to the first node N1. On the premise that the control of the conduction and non-conduction of the second pull-down module 15 can be achieved, the embodiments of the present disclosure do not make specific limitations in this regard.

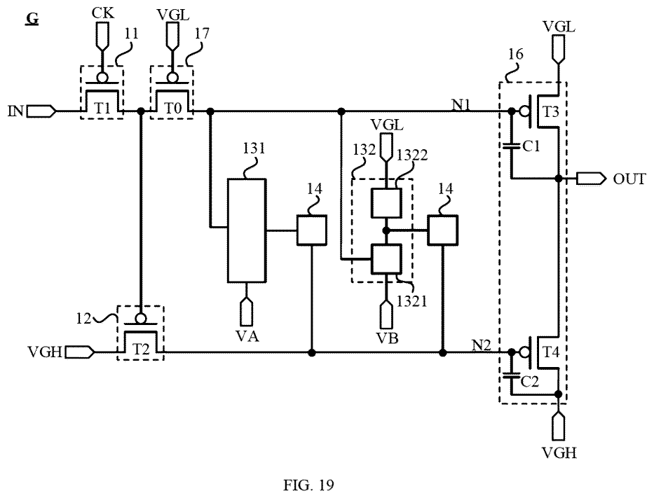

In an embodiment, referring to FIG. 19, the second turn-off control unit 1322 may be electrically connected only to the first level terminal VGL and the second pull-down module 15, and the second turn-on control unit 1321 may be electrically connected to the second control terminal VB, the first node N1 and the second pull-down module 15, respectively, and the second turn-on control unit 1321 and the second turn-off control unit 1322 are electrically connected to the same fourth node N4 as the second pull-down module 15. When the second turn-on control unit 1321 transmits the second control signal Vb to the fourth node N4 under the control of the signal VN1 of the first node N1, the second turn-off control unit 1322 can be turned on or off under the control of the signal of the fourth node N4 and the first level signal Vgl. In an embodiment, when the voltage difference between the signal of the fourth node N4 and the first level signal Vgl meets the turn-on condition of the second turn-off control unit 1322, the second turn-off control unit 1322 can be in the conducting state. When the voltage difference between the signal of the fourth node N3 and the first level signal Vgl does not meet the turn-on condition of the first turn-off control unit 1312, the second turn-off control unit 1322 can be in the non-conducting state. When the signal VN1 of the first node N1 cannot control the second turn-on control unit 1321 to be turned on, the second control signal Vb cannot be transmitted to the fourth node N4, and the second turn-off control unit 1322 can remain in the conducting state, so that the first level signal Vgl can be transmitted to the fourth node N4. Thus, by controlling the signal of the fourth node N4, it is possible to control the conduction or non-conduction of the second pull-down module 15 while controlling the conduction or non-conduction of the second turn-off control unit 1322.

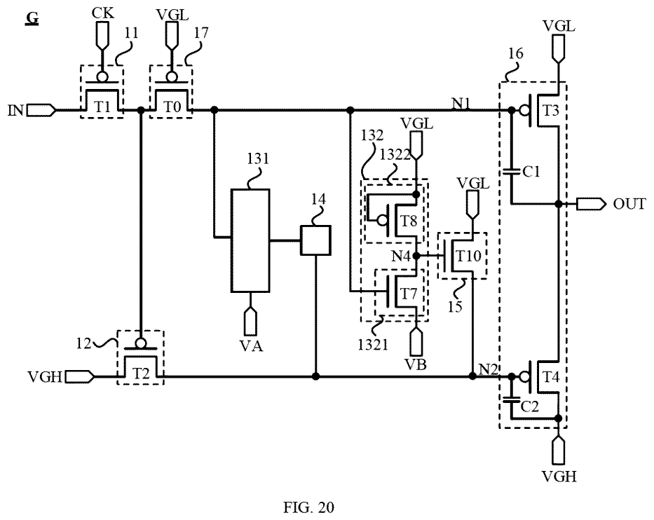

In an embodiment, referring to FIG. 20, when the second turn-on control unit 1321 includes the third transistor T7 and the second turn-off control unit 1322 includes the fourth transistor T8, the gate of the third transistor T7 is electrically connected to the first node N1, and the first electrode of the third transistor T7 receives the second control signal Vb. The gate of the fourth transistor T8 is electrically connected to the first electrode of the fourth transistor T8, and the first electrode of the fourth transistor T8 receives the first level signal Vgl. The second electrode of the fourth transistor T8 and the second electrode of the third transistor T7 are electrically connected to the fourth node N4. The second pull-down module 15 is electrically connected to the fourth node N4.

Since the gate of the third transistor T7 is electrically connected to the first node N1, the signal VN1 of the first node N1 can control the third transistor T7 to be turned on or off. When the signal VN1 of the first node N1 controls the third transistor T7 to be turned on, the second control signal Vb can be transmitted to the fourth node N4, so that the signal of the fourth node N4 is consistent with the second control signal Vb. When the signal of the first node N1 controls the third transistor T7 to be turned off, the second control signal Vb cannot be transmitted to the fourth node N4, and the signal of the fourth node N4 can be controlled by the signal transmitted by the fourth transistor T8. Both the first electrode and the gate of the fourth transistor T8 receive the first level signal Vgl, and the second electrode of the fourth transistor T8 is electrically connected to the fourth node N4. The fourth transistor T8 can be equivalent to a diode, that is, the fourth transistor T8 can have the characteristics of forward conduction and reverse blocking, so that the fourth transistor T8 can be turned on or off under the control of the signal of the fourth node N4 and the first level signal Vgl. In an embodiment, when the fourth transistor T8 is a P-type transistor, if the voltage difference between the first level signal Vgl and the signal of the fourth node N4 is greater than the threshold voltage of the fourth transistor T8, the fourth transistor T8 can be controlled to be in the conducting state, otherwise, the fourth transistor T8 is in the non-conducting state. Thus, when the signal of the first node N1 controls the third transistor T3 to be turned on, the second control signal Vb transmitted from the third transistor T7 to the fourth node N4 can be used to control the fourth transistor T8 to be turned on or off. When the second control signal Vb cannot be transmitted to the fourth node N4, the fourth transistor T8 can remain in the conducting state, so as to prevent the fourth node N4 from being in a floating state. This ensures that the signal of the fourth node N4 can accurately control the second pull-down module 15 to be turned on or off, so that the second pull-down module 15 can accurately pull down the signal VN2 of the second node N2.

It is understood that the channel types of the third transistor T7 and the fourth transistor T8 can be the same or different, which can be designed according to actual needs, and the embodiments of the present disclosure do not make specific limitations in this regard. In an embodiment, the third transistor T7 and the fourth transistor T8 can have different channel types. That is, the third transistor T7 is an N-type transistor and the fourth transistor T8 is a P-type transistor, or the third transistor T7 is a P-type transistor and the fourth transistor T8 is an N-type transistor, so as to meet the control requirements of the second turn-on control unit 1321 and the second turn-off control unit 1322.

Based on the above embodiments, in some embodiments, when the third transistor T7 is an N-type transistor and the fourth transistor T8 is a P-type transistor, the channel width-to-length ratio of the third transistor T7 can be greater than the channel width-to-length ratio of the fourth transistor T8.

The channel width-to-length ratio of the third transistor T7 is greater than that of the fourth transistor T8, which can be understood as adjusting the channel width and length of the fourth transistor T8 when the channel width and length of the third transistor T7 remain constant. In an embodiment, the channel width of the fourth transistor T8 can be decreased and/or the channel length of the fourth transistor T8 can be increased to decrease the threshold voltage of the fourth transistor T8 accordingly. Thus, when the signal VN1 of the first node N1 controls the third transistor T7 to be turned on, and the third transistor T7 transmits the second control signal Vb to the fourth node N4, it can be ensured that the second control signal Vb provided to the fourth node N4 can control the fourth transistor T8 to remain in the non-conducting state, thereby preventing the accuracy of the signal of the fourth node N4 from being affected by the simultaneous conduction of the third transistor T7 and the fourth transistor T8.

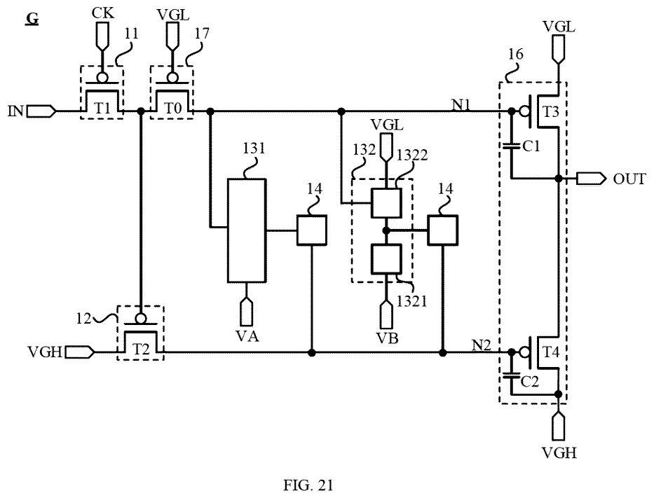

In an embodiment, referring to FIG. 21, the second turn-off control unit 1322 may be electrically connected to the first node N1, the first level terminal VGL, and the second pull-down module 15, respectively, and the second turn-on control unit 1321 may be electrically connected only to the second control terminal VB and the second pull-down module 15, and the second turn-on control unit 1321 and the second turn-off control unit 1322 are electrically connected to the same fourth node N4 as the second pull-down module 15. When the second turn-off control unit 1322 transmits the first level signal Vgl to the fourth node N4 under the control of the signal VN1 of the first node N1, the second turn-on control unit 1321 can be turned on or off under the control of the signal of the fourth node N4 and the second control signal Vb. In an embodiment, when the voltage difference between the second control signal Vb and the signal of the fourth node N4 meets the turn-on condition of the second turn-on control unit 1321, the second turn-on control unit 1321 can be in the conducting state. When the voltage difference between the second control signal Vb and the signal of the fourth node N4 does not meet the turn-on condition of the second turn-on control unit 1321, the second turn-on control unit 1321 can be in the non-conducting state. When the signal VN1 of the first node N1 cannot control the second turn-off control unit 1322 to be turned on, the first level signal Vgl cannot be transmitted to the fourth node N4, and the second turn-on control unit 1321 can remain in the conducting state, so that the second control signal Vb can be transmitted to the fourth node N4. Thus, by controlling the signal of the fourth node N4, it is possible to control the conduction or non-conduction of the second pull-down module 15 while controlling the conduction or non-conduction of the second turn-on control unit 1321.

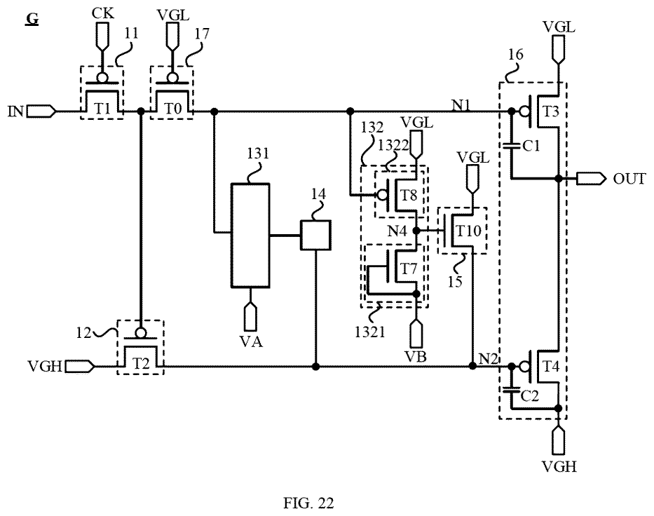

In an embodiment, referring to FIG. 22, when the second turn-on control unit 1321 includes the third transistor T7 and the second turn-off control unit 1322 includes the fourth transistor T8, the gate of the third transistor T7 is electrically connected to the first electrode of the third transistor T7, and the first electrode of the third transistor T7 receives the second control signal Vb. The gate of the fourth transistor T8 is electrically connected to the first node N1, the first electrode of the fourth transistor T8 receives the first level signal Vgl, and the second electrode of the fourth transistor T8 and the second electrode of the third transistor T7 are electrically connected to the fourth node N4. The second pull-down module 15 is electrically connected to the fourth node N4.

Since the gate of the fourth transistor T8 is electrically connected to the first node N1, the signal VN1 of the first node N1 can control the fourth transistor T8 to be turned on or off. When the signal VN1 of the first node N1 controls the fourth transistor T8 to be turned on, the first level signal Vgl can be transmitted to the fourth node N4, so that the signal of the fourth node N4 is consistent with the first level signal Vgl. When the signal of the first node N1 controls the fourth transistor T8 to be turned off, the first level signal Vgl cannot be transmitted to the fourth node N4, and the signal of the fourth node N4 can be controlled by the signal transmitted by the third transistor T7. Both the first electrode and the gate of the third transistor T7 receive the second control signal Vb, and the second electrode of the third transistor T7 is electrically connected to the fourth node N4. The third transistor T7 can be equivalent to a diode, that is, the third transistor T7 can have the characteristics of forward conduction and reverse blocking, so that the third transistor T7 can be turned on or off under the control of the signal of the fourth node N4 and the second control signal Vb. In an embodiment, when the third transistor T7 is an N-type transistor, if the voltage difference between the second control signal Vb and the signal of the fourth node N4 is greater than the threshold voltage of the third transistor T7, the third transistor T7 can be controlled to be in the conducting state, otherwise, the third transistor T7 is in the non-conducting state. Thus, when the signal of the first node N1 controls the fourth transistor T8 to be turned on, the first level signal Vgl transmitted from the fourth transistor T8 to the fourth node N4 can be used to control the third transistor T7 to be turned on or off. When the first level signal Vgl cannot be transmitted to the fourth node N4, the third transistor T7 can remain in the conducting state, so as to prevent the fourth node N4 from being in a floating state. This ensures that the signal of the fourth node N4 can accurately control the second pull-down module 15 to be turned on or off, so that the second pull-down module 15 can accurately pull down the signal VN2 of the second node N2.

It is understood that the channel types of the third transistor T7 and the fourth transistor T8 can be the same or different, which can be designed according to actual needs, and the embodiments of the present disclosure do not make specific limitations in this regard. In an embodiment, the third transistor T7 and the fourth transistor T8 can have different channel types to meet the control requirements of the first turn-on control unit 1311 and the second turn-off control unit 1312.

Based on the above embodiments, in some embodiments, when the third transistor T7 is an N-type transistor and the fourth transistor T8 is a P-type transistor, the channel width-to-length ratio of the third transistor T7 can be smaller than the channel width-to-length ratio of the fourth transistor T8.

The channel width-to-length ratio of the third transistor T7 is smaller than that of the fourth transistor T8, which can be understood as adjusting the channel width and length of the third transistor T7 when the channel width and length of the fourth transistor T8 remain constant. In an embodiment, the channel width of the third transistor T7 can be decreased and/or the channel length of the third transistor T7 can be increased to decrease the threshold voltage of the third transistor T7 accordingly. Thus, when the signal VN1 at the first node N1 controls the fourth transistor T8 to be turned on, and the fourth transistor T8 transmits the first level signal Vgl to the fourth node N4, it can be ensured that the first level signal Vgl provided to the fourth node N4 can control the third transistor T7 to remain in the non-conducting state, thereby preventing the accuracy of the signal of the fourth node N4 from being affected by the simultaneous conduction of the third transistor T7 and the fourth transistor T8.

It is understood that the above merely provides an exemplary explanation of the structures of the first pull-down control sub-module and the second pull-down control sub-module. In some embodiments of the present disclosure, the structures of the first pull-down control sub-module and the second pull-down control sub-module can be combined with each other, that is, the structures of the first pull-down control sub-module and the second pull-down control sub-module do not affect each other.

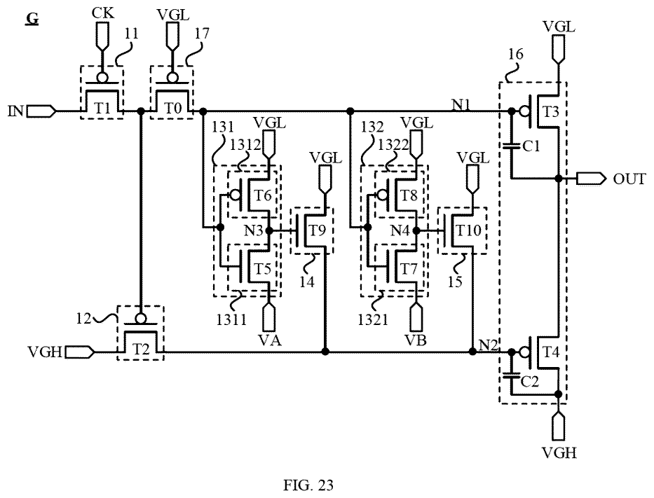

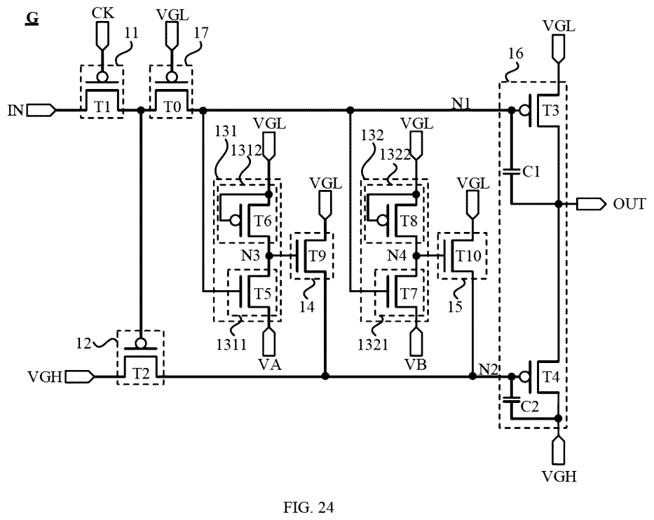

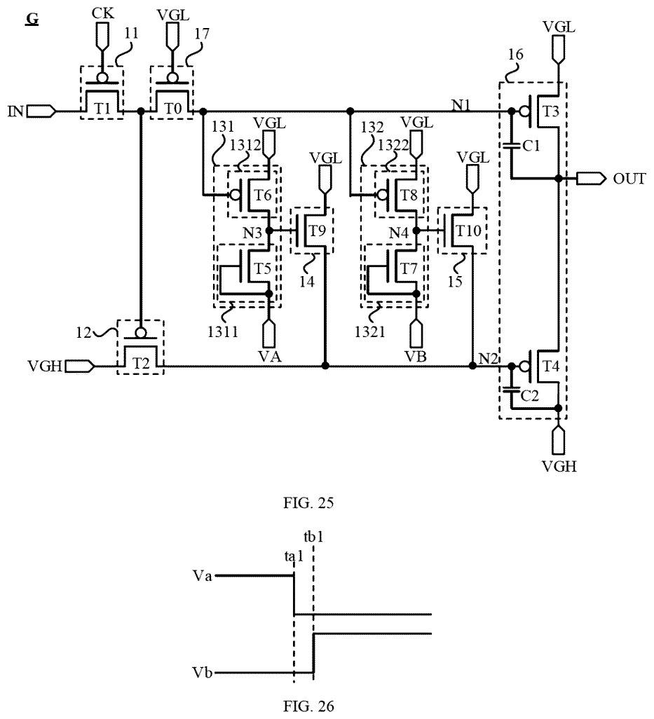

In an embodiment, referring to FIG. 23 to FIG. 25, the structure of the first pull-down control sub-module 131 can be the same or similar to the second pull-down control sub-module 132, so that the conducting duration of the first pull-down module 14 and the second pull-down module 15 can be controlled by controlling the first control signal Va provided to the first pull-down control sub-module 131 and the second control signal Vb provided to the second pull-down control sub-module 132. Thus, when the signal of the first node N1 is at a level that controls the first pull-down module 14 and the second pull-down module 15 to be turned on, the first pull-down module 14 and the second pull-down module 15 can be turned on in a time-division manner, which prevents the device performance and lifespan of the first pull-down module 14 and the second pull-down module 15 from being affected by the long individual conduction duration of the first pull-down module 14 and the second pull-down module 15, thereby simplifying the driving control logic of the shift register G and reducing the driving cost while prolonging the lifespan of the shift register G and the accuracy of the output gate driving signal Gout.

Based on the above embodiments, in some embodiments, referring to FIG. 23 to FIG. 25, the first pull-down module 14 includes a first pull-down transistor T9. A gate of the first pull-down transistor T9 is electrically connected to the pull-down control module, a first electrode of the first pull-down transistor T9 receives the first level signal Vgl, and a second electrode of the first pull-down transistor T9 is electrically connected to the second node N2. The pull-down control module can control the first pull-down transistor T9 to be turned on or off. When the pull-down control module controls the first pull-down transistor T9 to be turned on, the first level signal Vgl can be transmitted to the second node N2 through the first pull-down transistor T9, so that the signal VN2 of the second node N2 can be consistent with the first level signal Vgl.

When the pull-down control module includes the first pull-down control sub-module 131, and the first pull-down control sub-module 131 includes the first turn-on control unit 1311 and the first turn-off control unit 1312, the first turn-on control unit 1311 can control the first control signal Va to be provided to the gate of the first pull-down transistor T9 when the signal VN1 of the first node N1 is at a level that controls the first pull-down transistor T9 to be turned on, so that the first pull-down transistor T9 can be turned on or off under the control of the first control signal Va. The first turn-off control unit 1312 can control the first level signal Vgl to be provided to the gate of the first pull-down transistor T9 when the signal VN1 of the first node N1 is at a level that controls the first pull-down transistor T9 to be turned off, so that the first pull-down transistor T9 can be turned off under the control of the first level signal Vgl. If the first control signal Va includes the first control signal valid level and the first control signal invalid level, the polarity of the first control signal valid level and the first control signal invalid level can be designed according to the channel type of the first pull-down transistor T9. In an embodiment, when the first pull-down transistor T9 is an N-type transistor, the first control signal valid level can be high level and the first control signal invalid level can be low level. When the first pull-down transistor T9 is a P-type transistor, the first control signal valid level is low level and the first control signal invalid level is high level.

Correspondingly, if the first turn-on control unit 1311 includes the first transistor T5 the first turn-off control unit 1312 includes the second transistor T6, and the channel types of the first transistor T5 and the second transistor T6 are different, the channel type of the first transistor T5 can be the same as the channel type of the first pull-down transistor T9. In an embodiment, both the first transistor T5 and the first pull-down transistor T9 can be N-type transistors, and the second transistor T6 can be a P-type transistor. In an embodiment, both the first transistor T5 and the first pull-down transistor T9 can be P-type transistors, and the second transistor T6 can be an N-type transistor, which can be designed according to actual needs, and the embodiments of the present disclosure do not make specific limitations in this regard.

In some embodiments, referring to FIG. 23 to FIG. 25, the second pull-down module 15 includes a second pull-down transistor T10. A gate of the second pull-down transistor T10 is electrically connected to the pull-down control module, a first electrode of the second pull-down transistor T10 receives the first level signal Vgl, and a second electrode of the second pull-down transistor T10 is electrically connected to the second node N2. The pull-down control module can control the second pull-down transistor T10 to be turned on or off. When the pull-down control module controls the second pull-down transistor T10 to be turned on, the first level signal Vgl can be transmitted to the second node N2 through the second pull-down transistor T10, so that the signal VN2 of the second node N2 can be consistent with the first level signal Vgl.

When the pull-down control module includes the second pull-down control sub-module 132, and the second pull-down control sub-module 132 includes the second turn-on control unit 1321 and the second turn-off control unit 1322, the second turn-on control unit 1321 can control the second control signal Vb to be provided to the gate of the second pull-down transistor T10 when the signal VN1 of the first node N1 is at a level that controls the second pull-down transistor T10 to be turned on, so that the second pull-down transistor T10 can be turned on or off under the control of the second control signal Vb. The second turn-off control unit 1322 can control the first level signal Vgl to be provided to the gate of the second pull-down transistor T10 when the signal VN1 of the first node N1 is at a level that controls the second pull-down transistor T10 to be turned off, so that the second pull-down transistor T10 can be turned off under the control of the first level signal Vgl. If the second control signal Vb includes the second control signal valid level and the second control signal invalid level, the polarity of the second control signal valid level and the second control signal invalid level can be designed according to the channel type of the second pull-down transistor T10. In an embodiment, when the second pull-down transistor T10 is an N-type transistor, the second control signal valid level can be high level and the second control signal invalid level can be low level. When the second pull-down transistor T10 is a P-type transistor, the second control signal valid level is low level and the second control signal invalid level is high level.

Correspondingly, if the second turn-on control unit 1321 includes the third transistor T7 and the second turn-off control unit 1322 includes the fourth transistor T8, and the channel types of the third transistor T7 and the fourth transistor T8 are different, the channel type of the third transistor T7 can be the same as the channel type of the second pull-down transistor T10. In an embodiment, both the third transistor T7 and the second pull-down transistor T10 can be N-type transistors, and the fourth transistor T8 can be a P-type transistor. In an embodiment, both the third transistor T7 and the second pull-down transistor T10 can be P-type transistors, and the fourth transistor T8 can be an N-type transistor, which can be designed according to actual needs, and the embodiments of the present disclosure do not make specific limitations in this regard.

It is understood that when the first pull-down module 14 includes the first pull-down transistor T9 and the second pull-down module 15 includes the second pull-down transistor T10, the channel types of the first pull-down transistor T9 and the second pull-down transistor T10 can be the same or different, which can be designed according to actual needs. In an embodiment, the channel types of the first pull-down transistor T9 and the second pull-down transistor T10 can be the same. The polarity of the first control signal valid level controlling the first pull-down transistor T9 to be turned on is the same as the polarity of the second control signal valid level controlling the second pull-down transistor T10 to be turned on, and the polarity of the first control signal invalid level controlling the first pull-down transistor T9 to be turned off is the same as the polarity of the second control signal invalid level controlling the second pull-down transistor T10 to be turned off. In an embodiment, both the first control signal valid level and the second control signal valid level are high level, and both the first control signal invalid level and the second control signal invalid level are low level. In an embodiment, both the first control signal valid level and the second control signal valid level are low level, and both the first control signal invalid level and the second control signal invalid level are high level.

Since the conducting duration of the first pull-down module 14 does not overlap with the conducting duration of the second pull-down module 15, that is, the conducting duration of the first pull-down transistor T9 does not overlap with the conducting duration of the second pull-down transistor T10, the high-level duration or low-level duration of the first control signal Va can be set to not overlap.

In an embodiment, when the first control signal Va includes the first control signal valid level and the first control signal invalid level, and the second control signal Vb includes the second control signal valid level and the second control signal invalid level, the duration of the first control signal valid level does not overlap with the duration of the second control signal valid level.

When the pull-down control module provides the first control signal Va to the first pull-down module 14, the first pull-down module 14 can be controlled to be turned on or off. When the pull-down module provides the second control signal Vb to the second pull-down module 15, the second pull-down module 15 can be controlled to be turned on or off. When the first level signal Vgl is provided to the first pull-down module 14 and the second pull-down module 15, the first pull-down module 14 and the second pull-down module 15 can be controlled to be turned off. Therefore, the conducting duration of the first pull-down module 14 is within the duration when the first control signal Va is at the valid level of the first control signal, and the conducting duration of the second pull-down module 15 is within the duration when the second control signal Vb is at the valid level of the second control signal. By setting the duration of the first control signal valid level to not overlap with the duration of the second control signal valid level, the conduction duration of the first pull-down module 14 does not overlap with the conduction duration of the second pull-down module 15, thereby relatively shortening the individual conduction duration of the first pull-down module 14 and the second pull-down module 15, and preventing the first pull-down transistor T9 in the first pull-down module 14 and the second pull-down transistor T10 in the second pull-down module 15 from being in a forward or negative biased state for a long time due to prolonged conduction of the first pull-down module 14 and the second pull-down module 15. This causes the threshold voltages of the first pull-down transistor T9 and the second pull-down transistor T10 to drift or even fail, thereby prolonging the lifespan of the first pull-down transistor T9 and the second pull-down transistor T10, enabling the first pull-down transistors T9 and the second pull-down transistor T10 to accurately pull down the signal of the second node N2, ensuring the accuracy of the signal of the second node N2 and improving the accuracy of the gate driving signal Gout output by the output module 16 controlled by the signals of the first node N1 and the second node N2.

It is understood that when the valid level of the first control signal does not overlap with the valid level of the second control signal, the invalid level of the first control signal can overlap with or not overlap with the invalid level of the second control signal, which can be designed according to actual needs, and the embodiments of the present disclosure do not make specific limitations in this regard.

In an embodiment, taking the valid levels of the first control signal and the second control signal as high levels, and the invalid levels of the first control signal and the second control signal as low levels as an example, as shown in FIG. 26, the moment when the first control signal Va transitions from the valid level of the first control signal to the invalid level of the first control signal is ta, and the moment when the second control signal Vb transitions from the invalid level of the second control signal to the valid level of the second control signal is tb1. ta1 may precede tb1, so that within the time period between ta1 and tb1, the first control signal Va is at the invalid level of the first control signal, and the second control signal Vb is at the invalid level of the second control signal. That is, the duration of the first control signal invalid level overlaps with the duration of the second control signal invalid level.

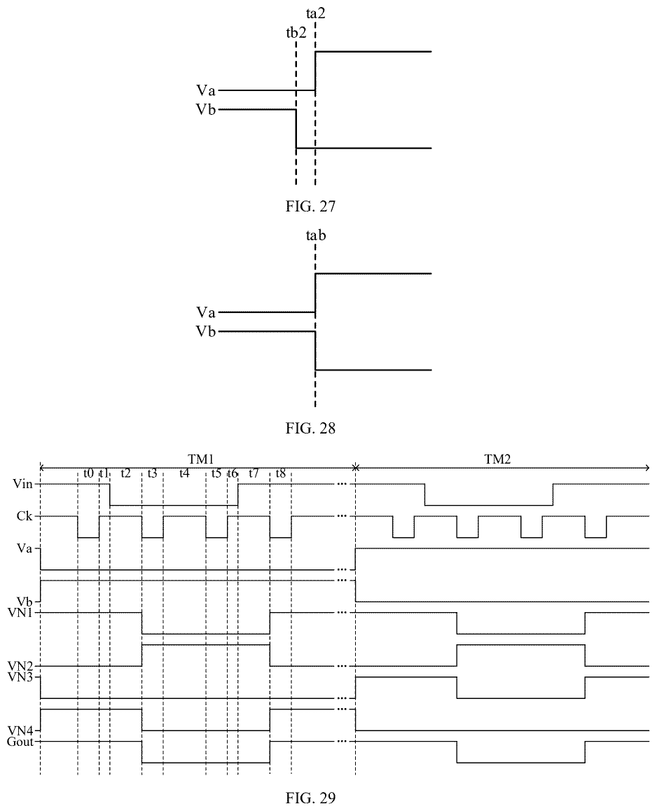

In an embodiment, as shown in FIG. 27, the moment when the first control signal Va transitions from the invalid level of the first control signal to the valid level of the first control signal is ta2, and the moment when the second control signal Vb transitions from the valid level of the second control signal to the invalid level of the second control signal is tb2. tb2 may precede ta2, so that within the time period between tb2 and ta2, the first control signal Va is at an invalid level of the first control signal, and the second control signal Vb is at an invalid level of the second control signal. That is, the duration of the first control signal invalid level overlaps with the duration of the second control signal invalid level.

In an embodiment, as shown in FIG. 28, the moment when the first control signal Va transitions from the invalid level of the first control signal to the valid level of the first control signal is tab, and the moment when the second control signal Vb transitions from the valid level of the second control signal to the invalid level of the second control signal is tab. That is, the transition moment of the first control signal Va and the transition moment of the second control signal Vb is the same moment. On the premise that the duration of the first control signal valid level does not overlap with the duration of the second control signal valid level, the duration of the first control signal invalid level does not overlap with the duration of the second control signal invalid level either. That is, at the same moment, the first control signal Va and the second control signal Vb can have opposite polarities. In other words, when the first control signal Va is at a high level, the second control signal Vb is at a low level, and when the first control signal Va is at a low level, the second control signal Vb is at a high level.

It is understood that within the time period when the first control signal Va is at an invalid level and the second control signal Vb is also at an invalid level, regardless of how the signal of the first node N1 changes, the first pull-down module 14 and the second pull-down module 15 are in the non-conducting state. The signal of the second node N2 may be in a floating state, so that the signal of the second node N2 may not be able to control the output module 16 to accurately output the gate driving signal Gout. Therefore, in some embodiments of the present disclosure, by setting the transition moment of the first control signal Va and the transition moment of the second control signal Vb to be the same moment, it is possible to ensure that, when the signal VN1 of the first node N1 is at the level that controls the first pull-down module 14 and the second pull-down module 15 to be turned on, one of the first control signal Va provided to the first pull-down module 14 and the second control signal Vb provided to the second pull-down module 15 is at an valid level. As a result, one of the first pull-down module 14 and the second pull-down module 15 is in the conducting state, enabling accurately pull-down of the signal of the second node N2, prevent the signal of the second node N2 from being in a floating state, and thereby ensuring that the signal VN2 of the second node N2 accurately controls the output module 16 to output the gate driving signal Gout.

It should be noted that the above merely provides an exemplary explanation of the structure of the shift register structure. On the premise that the core inventive points of the embodiments of the present disclosure can be realized, the structure of the shift register is not limited in the embodiments of the present disclosure. The following provides an exemplary explanation of the operation process of the shift register in conjunction with their driving timing.

In an embodiment, taking the shift register shown in FIG. 23 as an example, FIG. 29 is a driving timing diagram of a shift register according to an embodiment of the present disclosure. Referring to FIG. 23 and FIG. 29, taking, as an example, the case where the first node control transistor T1, the second node control transistor T2, the first output transistor T3, the second output transistor T4, the second transistor T6, and the fourth transistor T8 as P-type transistors, and the first transistor T5, the third transistor T7, the first pull-down transistor T9, and the second pull-down transistor T10 as N-type transistors, the first control signal valid level and the second control signal valid level may be high level, the first control signal invalid level and the second control signal invalid level may be low level, the valid level of the input signal Vin may be low level, the invalid level of the input signal Vin may be high level, the active pulse level of the clock signal Ck is low level, and the invalid level of the clock signal Ck is high level.

To ensure that both the first pull-down transistor T9 and the second pull-down transistor T10 have short conducting durations and their conducting durations do not overlap with each other, an operation process of the display panel can include at least two driving cycles TD1 and TD2. In driving cycle TD1, the first control signal Va may be at an valid level, and the second control signal Vb may be at an invalid level. In driving cycle TD2, the first control signal Va may be at an invalid level, and the second control signal Vb may be at an valid level. Correspondingly, each driving cycle of the shift register G may include at least stage t0, stage T1, stage T2, stage T3, stage T4, stage T5, stage T6, stage T7, and stage T8.

At stage T0 of the driving cycle TD1, the input signal Vin is at a high level, the clock signal Ck is at a low level, the first control signal Va is low, the second control signal Vb is at a high level, and the first node control transistor T1 is in the conducting state, so that the high level of the input signal Vin is transmitted to the first node N1, causing the signal VN1 of the first node N1 to be at a high level. The signal VN1 of the first node N1 controls the second node control transistor T2, the second transistor T6, the fourth transistor T8, and the first output transistor T3 to be in the non-conducting state, and controls the first transistor T5 and the third transistor T7 to be in the conducting state, so that the first control signal Va is transmitted to the third node N3 and the second control signal Vb is transmitted to the fourth node N4. The signal VN3 of the third node N3 is consistent with the first control signal Va, and the signal VN4 of the fourth node N4 is consistent with the second control signal Vb. That is, the signal VN3 of the third node N3 is at a low level, and the signal VN4 of the fourth node N4 is at a high level, the first pull-down transistor T9 is in the non-conducting state, and the second pull-down transistor T10 is in the conducting state. The second pull-down transistor T10 can transmit the first level signal Vgl to the second node N2, so that the signal VN2 of the second node N2 is at a low level consistent with the first level signal Vgl. The low-level signal VN2 of the second node N2 can control the second output transistor T4 to be in the conducting state, and the second output transistor T4 transmits the second level signal Vgh to the signal output terminal OUT, so that the signal output terminal OUT outputs a high-level gate driving signal Gout.

In stage t1 of drive cycle TD1, the input signal Vin remains at a high level, the clock signal Ck becomes at a high level, the first control signal Va remains at a low level, the second control signal Vb remains at a high level, and the first node control transistor T1 is in the non-conducting state and cannot write a signal to the first node N1, so that the signal VN1 of the first node N1 remains the signal written in stage t0. Since the signal VN1 of the first node N1 remains unchanged, the signal VN2 of the second node N2, the signal VN3 of the third node N3, and the signal VN4 of the fourth node N4 also remain unchanged. The signal output terminal OUT continues to output the high-level gate driving signal Gout.

In stage t2 of drive cycle TD1, the input signal Vin becomes at a low level, the clock signal Ck remains at a high level, the first control signal Va remains at a low level, the second control signal Vb remains at a high level, and the first node control transistor T1 remains in the non-conducting state and cannot write a signal to the first node N1, so that the signal VN1 of the first node N1 remains the signal written in stage t0. Since the signal VN1 of the first node N1 remains unchanged, the signal VN2 of the second node N2, the signal VN3 of the third node N3, and the signal VN4 of the fourth node N4 also remain unchanged. The signal output terminal OUT continues to output the high-level gate driving signal Gout.

In stage t3 of drive cycle TD1, the input signal Vin remains at a low level, the clock signal Ck becomes at a low level, the first control signal Va remains at a low level, the second control signal Vb remains at a high level, the first node control transistor T1 is turned on again, so that the low-level input signal Vin is transmitted to the first node N1, and the signal VN1 of the first node N1 changes from high level to low level. The low-level signal VN1 of the first node N1 can control the second node control transistor T2, the first output transistor T3, the second transistor T6, and the fourth transistor T8 to be turned on, and control the first transistor T5 and the third transistor T7 to be turned off, so that the first output transistor T3 transmits the first level signal Vgl to the signal output terminal OUT, causing the signal output terminal OUT to output a low-level gate driving signal Gout. The second node control transistor T2 can transmit the second level signal Vgh to the second node N2, so that the signal VN2 of the second node N2 is at a high level consistent with the second level signal Vgh, and the signal VN2 of the second node N2 controls the second output transistor T4 to be in the non-conducting state. The second transistor T6 transmits the first level signal Vgl to the third node N3, so that the signal VN3 of the third node N3 is at a low level consistent with the first level signal Vgl, and the first pull-down transistor T9 is in the non-conducting state. The fourth transistor T8 transmits the first level signal Vgl to the fourth node N4, so that the signal VN4 of the fourth node N4 is at a low level consistent with the first level signal Vgl, and the second pull-down transistor T19 is also in the non-conducting state.

In stage t4 of drive cycle TD1, the input signal Vin remains at a low level, the clock signal Ck becomes at a low level, the first control signal Va remains at a low level, the second control signal Vb remains at a high level, and the first node control transistor T1 is in the non-conducting state and cannot write a signal to the first node N1, so that the signal VN1 of the first node N1 remains the signal written in stage t3. Since the signal VN1 of the first node N1 remains unchanged, the signal VN2 of the second node N2, the signal VN3 of the third node N3, and the signal VN4 of the fourth node N4 also remain unchanged. The signal output terminal OUT continues to output the low-level gate driving signal Gout.

In stage t5 of drive cycle TD1, the input signal Vin remains at a low level, the clock signal Ck becomes at a high level, the first control signal Va remains at a low level, the second control signal Vb remains at a high level, the first node control transistor T1 is in the conducting state, and the first node control transistor T1 continues to supply the first node N1 with a low-level input signal Vin, so that the signal VN1 of the first node N1 remains at a low level. Since the signal VN1 of the first node N1 remains at a low level, the signal VN2 of the second node N2 remains at a high level, the signal VN3 of the third node N3 remains at a low level, and the signal VN4 of the fourth node N4 remains at a low level. The signal output terminal OUT continues to output the low-level gate driving signal Gout.

In stage t6 of drive cycle TD1, the input signal Vin remains at a low level, the clock signal Ck becomes at a high level, the first control signal Va remains at a low level, the second control signal Vb remains at a high level, and the first node control transistor T1 is in the non-conducting state and cannot write a signal to the first node N1, so that the signal VN1 of the first node N1 remains the signal written in stage t4. Since the signal VN1 of the first node N1 remains unchanged, the signal VN2 of the second node N2, the signal VN3 of the third node N3, and the signal VN4 of the fourth node N4 also remain unchanged. The signal output terminal OUT continues to output the low-level gate driving signal Gout.

In stage t7 of drive cycle TD1, the input signal Vin becomes at a high level, the clock signal Ck remains at a high level, the first control signal Va remains at a low level, the second control signal Vb remains at a high level, and the first node control transistor T1 is in the non-conducting state and cannot provide the high-level input signal Vin to the first node N1, so that the signal VN1 of the first node N1 remains the signal written in stage t6. Since the signal VN1 of the first node N1 remains unchanged, the signal VN2 of the second node N2, the signal VN3 of the third node N3, and the signal VN4 of the fourth node N4 also remain unchanged. The signal output terminal OUT continues to output the low-level gate driving signal Gout.

In stage t8 of drive cycle TD1, the input signal Vin remains at a high level, the clock signal Ck becomes at a low level, the first control signal Va remains at a low level, the second control signal Vb remains at a high level, and the first node control transistor T1 is turned on again, so that the high level of the input signal Vin is transmitted to the first node N1, causing the signal VN1 of the first node N1 to be at a high level. The signal VN1 of the first node N1 controls the second node control transistor T2, the second transistor T6, the fourth transistor T8, and the first output transistor T3 to be in the non-conducting state, and controls the first transistor T5 and the third transistor T7 to be in the conducting state, so that the first control signal Va is transmitted to the third node N3, and the second control signal Vb is transmitted to the fourth node N4. The signal VN3 of the third node N3 is consistent with the first control signal Va, and the signal VN4 of the fourth node N4 is consistent with the second control signal Vb. That is, the signal VN3 of the third node N3 is at a low level, and the signal VN4 of the fourth node N4 is at a low level, the first pull-down transistor T9 is in the non-conducting state, the second pull-down transistor T10 is in the conducting state, and the second pull-down transistor T10 can transmit the first level signal Vgl to the second node N2, so that the signal VN2 of the second node N2 is at a low level consistent with the first level signal Vgl. The low-level signal VN2 of the second node N2 can control the second output transistor T4 to be turned on again, and the second output transistor T4 transmits the second level signal Vgh to the signal output terminal OUT, so that the signal output terminal OUT output the high-level gate driving signal Gout.

After stage t8 of drive cycle TD1, if the input signal Vin remains at a high level, then regardless of how the clock signal Ck changes, the signal VN1 of the first node N1 remains at a high level, so that the signal output terminal OUT continues to output the high-level gate driving signal Gout.

In drive cycle TD2, the difference from the driving cycle TD1 is that the first control signal Va remains at a high level and the second control signal Vb remains at a low level. Thus, when the signal of the first node N1 controls the first transistor T5 and the third transistor T7 to be turned on, the signal VN3 of the third node N3 is at a high level and the signal VN4 of the fourth node N4 is at a low level. This causes the first pull-down transistor T9 to be in the conducting state and the second pull-down transistor T10 to be in the non-conducting state, so that the first level signal Vgl is transmitted to the second node N2 through the first pull-down transistor T9, thereby making the signal VN2 of the second node N2 be at a low level consistent with the first level signal Vgl. As a result, the second output transistor T4 is controlled to be turned on, so that the output terminal OUT outputs the high-level gate driving signal Gout.

In summary, by setting the levels of the first control signal Va and the second control signal Vb, in drive cycle TD1, when the signal of the first node N1 is at a high level, the second pull-down transistor T10 can pull down the signal VN2 of the second node N2. In drive cycle TD2, when the signal of the first node N1 is at a high level, the first pull-down transistor T9 can pull down the signal VN2 of the second node N2. Thus, by allowing the first pull-down transistor T9 and the second pull-down transistor T10 to be in the conducting state in different drive cycles, the individual conduction duration of the first pull-down transistor T9 and the second pull-down transistor T10 is shortened. This is favorable for prolonging the lifespan of the first pull-down transistor T9 and the second pull-down transistor T10, ensuring that the first pull-down transistor T9 and the second pull-down transistor T10 can accurately pull down the signal VN2 of the second node N2, and improving the accuracy of the signal VN2 of the second node N2, and thus improving the accuracy of the gate driving signal Gout output from the signal output terminal OUT.

It is understood that the above merely provides an exemplary explanation of the transition between the first control signal Va and the second control signal Vb. In some embodiments of the present disclosure, the specific transition between the first control signal Va and the second control signal Vb can be designed according to actual needs, and the embodiments of the present disclosure do not make specific limitations in this regard.

In an embodiment, referring to FIG. 23 and FIG. 29, the display time of one frame of the display panel includes a plurality of active pulses of the clock signal Ck. The time interval between the start moments of two adjacent active pulses of the clock signal Ck is a clock cycle. The transition cycle between the first control signal valid level and the first control signal invalid level is M times of the clock cycle. The transition cycle between the second control signal valid level and the second control signal invalid level is M times of the clock cycle, where M is a positive integer greater than or equal to 2.

Since the time interval between the start moments of two active pulses of the clock signal Ck of a pixel is a clock cycle, that is, the clock signal Ck in one clock cycle includes one active pulse and an invalid level between two adjacent active pulses. When the clock signal Ck transitions to a low level in the shift register G, the first node control transistor T1 can be controlled to be in the conducting state, so that the input signal Vin is transmitted to the first node N1. The signal VN1 of the first node N1 is used to control the first output transistor T3 to be turned on or off. When the signal VN1 of the first node N1 controls the first output transistor T3 to be turned on, the signal output terminal OUT outputs the low level of the gate driving signal Gout, and the low level duration of the gate driving signal Gout is greater than or equal to two clock cycles. When the signal VN1 of the first node N1 controls the first output transistor T3 to be turned off, the signal output terminal OUT outputs the high level of the gate driving signal GOUT. Thus, by setting the transition cycle between the first control signal valid level and the first control signal invalid level to be greater than or equal to two clock cycles, and further setting the transition cycle between the second control signal valid level and the second control signal invalid level to be greater than or equal to two clock cycles, the first control signal Va can remains at either the first control signal valid level or the first control signal invalid level, and the second control signal Vb can remains at either the second control signal valid level or the second control signal invalid level, during the time period in which the signal output terminal OUT outputs the low level of the gate driving signal Gout. This prevents the first control signal Va and/or the second control signal Vb from transitioning during the low-level time period of the gate driving signal Gout output from the signal output terminal OUT, which may affect the output accuracy of the gate driving signal Gout.

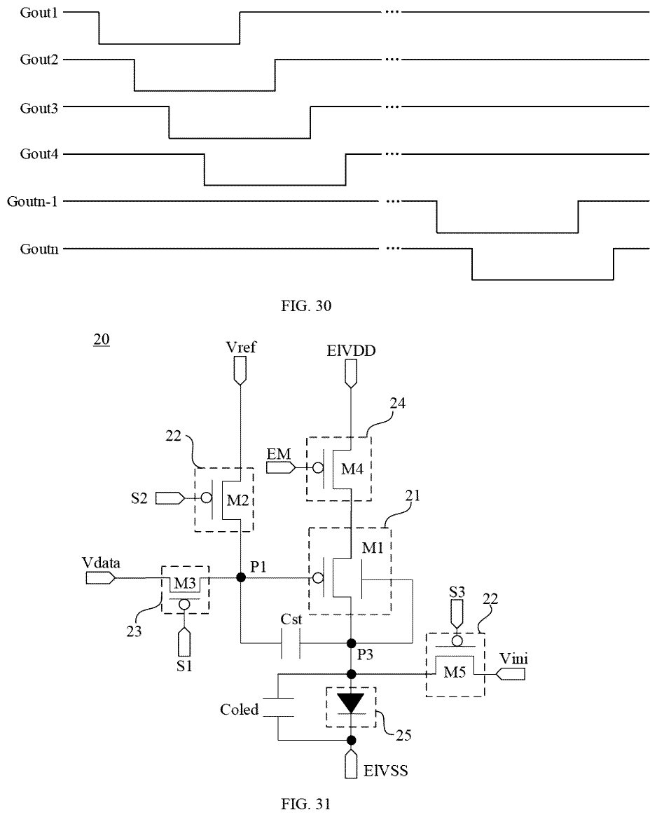

It is understood that in the display panel, the valid levels of the gate driving signals output by each stage of the shift registers in the driving circuit are sequentially shifted. Referring to FIG. 30, the valid level start moment of the gate driving signal Gout1 output by the first stage shift register precedes the valid level start moment of the gate driving signal Gout2 output by the second stage shift register, the valid level start moment of the gate driving signal Gout2 output by the second stage shift register precedes the valid level start moment of the gate driving signal Gout3 output by the third stage shift register, the valid level start moment of the gate driving signal Gout3 output by the third stage shift register precedes the valid level start moment of the gate driving signal Gout4 output by the fourth stage shift register, and so on. The valid level start moment of the gate driving signal Goutn-1 output by the n-th stage shift register precedes the valid level start moment of the gate driving signal Goutn output by the n-th stage shift register. Thus, the display time of one frame of the display panel can be equivalent to the time period between the valid level start moment of the gate driving signal Gout1 output by the first stage shift register and the valid level end moment of the gate driving signal Goutn output by the nth-stage shift register.

It is also understood that the display panel may include a plurality of pixel circuits arranged in an array, enabling each stage of shift registers in the driving circuit to scan each row of the pixel circuit line by line. In an embodiment, referring to FIG. 1 and FIG. 3, the display panel 100 may further include a plurality of gate signal lines 31. At least part of the pixel circuits 20 located in the same row may be electrically connected to the same gate signal line 31, and each stage of shift registers G may be electrically connected to each gate signal line 31, so that the gate driving signal Gout output by each stage of shift registers G can be provided to each row of pixel circuit 10 through each gate signal line 31. When the gate driving signal Gout output by each stage of shift registers G has high accuracy, each shift register G has high scanning accuracy for each row of the pixel circuit 20, enabling the signal to be accurately written to each row of the pixel circuit 20, thereby improving the display effect of the display panel 100.

In an embodiment, referring to FIG. 1 and FIG. 30, when the plurality of pixel circuits 20 and the plurality of gate signal lines 31 are arranged in an array, the pixel circuit 20 may include a preset module. At least part of the preset modules of the pixel circuits 20 located in the same row are electrically connected to the same gate signal line 31, so that each stage of the shift registers G provides corresponding gate driving signal Gout (Gout1, Gout2, Gout3, Gout4, . . . , Goutn-1, Goutn) to each gate signal line 31, causing the preset module to be turned on or off under the control of the gate driving signal Gout output by the shift register G. When the gate driving signal Gout is at an valid level, the preset module can be controlled to be turned on, and signal transmission can be performed between the nodes connected to the preset module. When the gate driving signal Gout is at an invalid level, the preset module can be controlled to be turned off, and signal transmission cannot be performed between the nodes connected to the preset module. Thus, the gate driving signal Gout output by the shift register G can control the driving process of the pixel circuit 20.

It is understood that the preset module may include active and/or passive devices. In an embodiment, active devices may include transistors, and passive devices may include capacitors, resistors, inductors, etc. When the preset module includes a PMOS (P-channel Metal Oxide Semiconductor) transistor, the low level of the gate driving signal serves as the valid level of the gate driving signal, and the high level of the gate driving signal serves as the invalid level of the gate driving signal. Conversely, when the preset module includes an NMOS (N-channel metal oxide semiconductor) transistor, the high level of the gate driving signal serves as the valid level of the gate driving signal, and the low level of the gate driving signal serves as the invalid level of the gate driving signal. For ease of description, unless otherwise specified, the embodiments of the present disclosure exemplarily illustrate the technical solutions using the case where the transistors in the preset module are all PMOS transistors.

It is also understood that the preset module in the pixel circuit 20 may be any module in pixel circuit 20, and can be selected according to actual needs. The pixel circuit 20 and its preset module mentioned in the embodiments of the present disclosure will be described exemplarily below with typical examples.

FIG. 31 is a structural schematic diagram of a pixel circuit according to an embodiment of the present disclosure. As shown in FIG. 31, the pixel circuit 20 includes at least a driving module 21, a writing module 23, a reset module 22, and a light-emitting module 25. The driving module 21 includes a driving transistor M1. The writing module 23 and a gate of the driving transistor MD are electrically connected to a gate node P1. The reset module 22 is electrically connected to the gate node P1. The reset module 22 and the light-emitting module 25 are electrically connected to a light-emitting reset node P3.

The driving cycle of the pixel circuit 20 may include a reset stage, a data writing stage, and a light emission stage that are sequentially performed. In the reset stage, the reset module 22 can provide a reset signal Vref to the gate node P1 and the light-emitting reset node P3 to reset the gate of the driving transistor M1 and the light-emitting reset node P3. In the data writing stage, the writing module 23 can provide a data signal Vdata to driving transistor M1. In the light emission stage, the driving module 21 provides a driving current to the light-emitting module 25 based on the gate signal of its driving transistor M1 to drive the light-emitting module 25 to emit light.

In an embodiment, the driving transistor M1 may be a dual-gate structure, that is, the driving transistor M1 may include a main gate and an auxiliary gate. The main gate may be connected to the gate node P1, and the auxiliary gate may be connected to the light-emitting reset node P3, which can reduce the internal resistance of the driving transistor M1 and improve the transmission efficiency of the driving current.

Based on the above embodiments, the reset module 22 may include a first reset transistor M2 and a second reset transistor M5. A first electrode of the first reset transistor M2 can receive a first reset signal Vref, and a second electrode of the first reset transistor M2 and a gate of the driving transistor M1 are electrically connected to the gate node P1. A gate of the first reset transistor M2 can receive a second scan signal S2. The first reset transistor M2 can be turned on or off under the control of the second scan signal S2. When the second scan signal S2 controls the first reset transistor M2 to be turned on, the first reset signal Vref can be transmitted to the gate of the driving transistor M1 to reset the gate of the driving transistor M1 and prepare for the subsequent writing of the data signal Vdata. A first electrode of the second reset transistor M5 can receive a second reset signal Vini, and a second electrode of the second reset transistor M5 and the light-emitting module 25 are electrically connected to the light-emitting reset node P3. A gate of the second reset transistor M5 can receive a third scan signal S3. The second reset transistor M5 can be turned on or off under the control of the third scan signal S3. When the third scan signal S3 controls the second reset transistor M5 to be turned on, the second reset signal Vini can be transmitted to the light-emitting module 25 to reset the light-emitting module 25.

Based on the above embodiments, in some embodiments, the writing module 23 may include a writing transistor M3. A first electrode of the writing transistor M3 can receive the data signal Vdata, and a second electrode of the writing transistor M3 is electrically connected to the gate node P1 of the driving module 21. A gate of the writing transistor M3 can receive a first scan signal S1. The first scan signal S1 can control the writing transistor M3 to be turned on or off, when the writing transistor M3 is in the conducting state, the data signal Vdata can be written to the driving module 21, thereby realizing the writing of the data signal Vdata.

In some embodiments, the light-emitting module 25 may include a current-driven element, which can only drive the light-emitting module 25 to display and emit light when the display driving signal provided to the light-emitting module 25 is the driving current. The data signal Vdata provided by the writing module 23 is typically a voltage signal. It is necessary to set up the driving module 21 in the pixel circuit 20, so that the driving transistor M1 of the driving module 21 can convert the data signal Vdata into a driving current. When this driving current is provided to the light-emitting module 25, the light-emitting module 25 can display and emit light according to the driving current, and generally, the larger the driving current, the higher the brightness of the light-emitting module 25. Thus, by providing data signals Vdata to each pixel circuit 20 respectively, the brightness of each light-emitting module 25 can be controlled separately, thereby enabling the display panel to display rich and colorful images. The light-emitting module 25 may include current-driven light-emitting elements such as OLED (Organic Light Emitting Diode), Mini LED, or Micro LED.

In some embodiments, referring to FIG. 31, the pixel circuit 20 may further include a light-emitting control module 24. The light-emitting control module 24 includes a light-emitting control transistor M4. A first electrode of the light-emitting control transistor M4 is electrically connected to a first power supply signal ELVDD, and a second electrode of the light-emitting control transistor M4 is electrically connected to one end of the driving module 21. A gate of the light-emitting control transistor M4 is electrically connected to a light-emitting control signal EM. The light-emitting control transistor M4 can be turned on or off under the control of the light-emitting control signal EM. When the light-emitting control signal EM controls the light-emitting control transistor M4 to be turned on, the first power supply signal ELVDD can be transmitted to the driving transistor M1. The light-emitting control module 25 can control the duration during which the driving module 21 provides driving current to the light-emitting module 25, so as to control the light-emitting time of the light-emitting module 25.

In addition, the pixel circuit 20 further includes a storage capacitor Cst and a voltage regulator capacitor Coled. The storage capacitor Cst is electrically connected between the gate node P1 and the light-emitting reset node P3, and is configured to store the gate potential and threshold voltage of the driving transistor M1, so as to ensure that the driving transistor M1 can continuously provide the light-emitting module 25 with a driving current independent of the threshold voltage of the driving transistor M1 during the light-emitting phase. The voltage regulator capacitor Coled is connected in parallel with the light-emitting module 25, which can stabilize the driving current of the light-emitting module 25, suppress the display brightness fluctuation of the light-emitting module 25, and improve the light-emitting stability of the light-emitting module 25.

It should be noted that the above only provides an exemplary explanation of the structure of pixel circuit 20. In some embodiments of the present disclosure, the structure of pixel circuit 20 is not limited to this. In an embodiment, the pixel circuit 20 may be a typical 7T1C pixel circuit, that is, the pixel circuit includes seven transistors and one storage capacitor. On the premise that the core inventive points of the embodiments of the present disclosure can be realized, the embodiments of the present disclosure do not make specific limitations in this regard. For ease of description, unless otherwise specified, the embodiments of the present disclosure exemplarily illustrate the technical solutions using the case of the structure of the pixel circuit shown in FIG. 31.

In an embodiment, referring to FIG. 31, the preset module in the pixel circuit 20 may include one of the reset module 22, the writing module 23 and the light-emitting control module 24. The gate driving signal Gout output by the shift register G in the driving circuit 10 may be one of the first scan signal S1, the second scan signal S2, the third scan signal S3 and the light-emitting control signal EM.

In an embodiment, the preset module in the pixel circuit 20 may be the reset module 22. The reset modules 22 of at least part of the pixel circuits 20 located in the same row are electrically connected to the same gate signal line 31. The gate driving signal Gout output by the shift register G can be the second scan signal S2 received by the reset module 22. Since each stage of the shift registers G is electrically connected to each gate signal line 31, the gate driving signal Gout output by the shift register G can be transmitted to the reset module 22 of the pixel circuit 20 through the gate signal line 31, so as to control the reset module 22 to be turned on or off. When the gate driving signal Gout controls the first reset transistor M2 in the reset module 22 to be turned on, the first reset signal Vref can be written to the gate of the driving transistor M1, so as to reset the gate of the driving transistor M1, clear the signal written to the gate of the driving transistor M1 in the previous cycle, and ensure that the data signal Vdata in the current cycle is accurately written to the gate of the driving transistor M1.

In some embodiments, the preset module in the pixel circuit 20 may be the writing module 23. The writing modules 23 of at least part of the pixel circuits 20 located in the same row are electrically connected to the same gate signal line 31. The gate driving signal Gout output by the shift register G can be the first scan signal S1 received by the writing module 23. Since each stage of the shift registers G is electrically connected to each gate signal line 31, the gate driving signal Gout output by the shift register G can be transmitted to the writing module 23 of the pixel circuit 20 through the gate signal line 31, so as to control the writing module 23 to be turned on or off. When the gate driving signal Gout controls the writing transistor M3 in the writing module 23 to be turned on, the data signal Vdata can be written to the gate of the driving transistor M1, so that the driving transistor M1 can control the light-emitting module 25 to display and emit light based on the written data signal Vdata during the light-emitting phase.

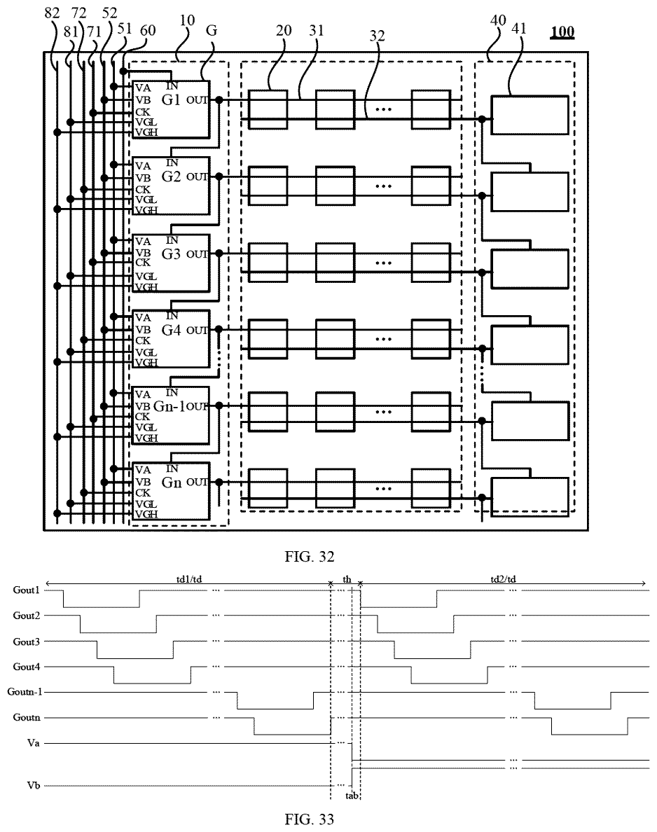

In some embodiments, the display panel may further include a scanning circuit for controlling other transistors in the pixel circuits to be turned on or off. In an embodiment, referring to FIG. 31 and FIG. 32, the display panel further includes a scanning circuit 40. The scanning circuit includes a plurality of stages of scanning units 41 arranged in a cascaded manner and a plurality of scanning signal lines 32. Each stage of scanning units 41 can be electrically connected to each scanning signal line 32, and at least one of the other modules, except for the preset module, of at least part of the pixel circuits 20 located in the same row is electrically connected to the same scanning signal line 32. The scan signals output by each stage of scanning units 41 can be provided to at least one of the other modules of each row of pixel circuits 20 through each scanning signal line 32, so as to control the signal writing of each row of pixel circuits 20, and ensure that each row of pixel circuits 20 emits light accurately.

It is understood that the above merely provides an exemplary explanation of the shift register G and the manner in which the shift register G provides gate driving signals to the pixel circuit 20. On the premise that the core inventive points of the embodiments of the present disclosure can be realized, the embodiments of the present disclosure do not make specific limitations in this regard. For ease of description, unless otherwise specified, the embodiments of the present disclosure exemplarily illustrate the technical solutions using the case where each stage of shift registers of the driving circuit provide gate driving signals to the writing module of the pixel circuit.

In an embodiment, referring to FIG. 32 and FIG. 33, the display time td of one frame of the display panel 100 includes at least a data writing frame. The display panel 100 further includes a plurality of pixel circuits 20 arranged in an array. The data writing frame includes a data writing phase of each row of pixel circuits 20. In the display time td of two adjacent frames, the time between the last data writing stage of the display time td1 of the previous frame and the first data writing stage of the display time td2 of the next frame is an time interval th. The transition moment tab between the first control signal valid level and the first control signal invalid level is located within the time interval th. The transition moment tab between the second control signal valid level and the second control signal invalid level is located within the time interval th.

Since the first control terminal VA of each stage of shift registers G is electrically connected to the same first control signal line 51, and the second control terminal VB of each stage of shift registers G is electrically connected to the same second control signal line 52, each stage of shift registers G receives the same first control signal Va and the same second control signal Vb. Therefore, the first pull-down module of each stage of shift registers G can be turned on or off under the control of the same first control signal Va, and the second pull-down module of each stage of shift registers G can be turned on or off under the control of the same second control signal Vb. If the transition moment tab between the first control signal valid level and the first control signal invalid level is located within the duration between the first data writing phase and last data writing phase of the display time td of a frame, then the transition moment tab between the first control signal valid level and the first control signal invalid level is located within the valid level duration of the gate driving signal Gout output by one of the stages of the shift registers G, so that the transition of the first control signal Va affects the accuracy of the gate driving signal Gout of that stage of the shift register G. If the transition moment tab between the second control signal valid level and the second control signal invalid level is located within the duration between the first data writing phase and last data writing phase of the display time td of a frame, then the transition moment tab between the second control signal valid level and the second control signal invalid level is located within the valid level duration of the gate driving signal Gout output by one of the stages of the shift registers G, so that the transition of the second control signal Vb affects the accuracy of the gate driving signal Gout of that stage of the shift register G. Thus, by ensuring that the transition moment tab between the first control signal valid level and the first control signal invalid level is located within the time interval th, and that the transition moment tab between the second control signal valid level and the second control signal invalid level is located within the time interval th, it is possible to prevent the transition of the first control signal Va and the second control signal Vb from affecting the accuracy of the gate driving signal Gout of the shift register G. This is favorable for improving the accuracy of the gate driving signal Gout output by each stage of the shift registers G, and thus improving the display effect of the display panel 100.

Based on the above embodiments, in some embodiments, the display panel 100 may further include a start signal line 60. When y-x is equal to 1, the signal input terminal IN of the first stage shift register G1 is electrically connected to the start signal line 60, so that the first stage shift register G1 can output a corresponding gate driving signal Gout1 to the signal input terminal IN of the second stage shift register G2 under the control of the start control signal transmitted by the start signal line 60, and so on. Such a design allows the gate driving signal output by the previous stage shift register to serve as the input signal of the next stage shift register. Thus, by controlling the start control signal transmitted by the start signal line 60, each stage of the shift registers G can be controlled to sequentially output the valid level of the gate driving signal Gout.

Based on the above embodiments, in some embodiments, the display panel 100 may further include clock signal lines (71 and 72). To ensure that the valid level start moment of the gate driving signal Gout output by two adjacent shift registers G is shifted sequentially, the active pulse duration of the clock signal Ck received by two adjacent shift registers G is shifted sequentially in the same clock cycle. The display panel 100 may include a first clock signal line 71 and a second clock signal line 72. The clock terminals of the odd-numbered stages of the shift registers G can be electrically connected to the first clock signal line 71, and the clock terminals of the even-numbered stages of the shift registers G can be electrically connected to the second clock signal line 72. In the same clock cycle, the active pulse duration of the clock signal transmitted by the first clock signal line 71 and the clock signal transmitted by the second clock signal line 72 is shifted sequentially. Thus, the active pulse duration of the gate driving signal Gout output by each stage of shift registers G can be shifted sequentially.

Based on the above embodiments, in some embodiments, the display panel 100 may further include a first level signal line 81 and a second level signal line. The first level terminal VGL of each stage of shift registers G can be electrically connected to the same first level signal line 81, and the second level terminal VGH of each stage of shift registers G can be electrically connected to the same second level signal line 82. Thus, it is unnecessary to separately provide the first level signal line 81 and the second level signal line 82 for each stage of shift registers G, which is favorable for reducing the number of signal lines provided in the display panel 100, and thus facilitating a narrow bezel of the display panel 100.

Based on the same inventive concept, the present disclosure further provides a display apparatus. The display apparatus includes the display panel according to the present disclosure. Therefore, the display apparatus has the technical features of the display panel according to the embodiments of the present disclosure and can achieve the beneficial effects of the display panel according to the embodiments of the present disclosure. The similarities can be found in the above description of the display panel according to the embodiments of the present disclosure, which will not be repeated here.

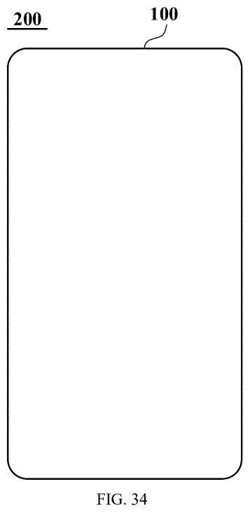

FIG. 34 is a structural schematic diagram of a display apparatus according to an embodiment of the present disclosure. As shown in FIG. 34, the display apparatus 200 includes a display panel 100 according to the embodiments of the present disclosure. The display apparatus 200 according to the embodiments of the present disclosure may be any electronic product with display function, including but not limited to the following categories: mobile phones, televisions, laptops, desktop monitors, tablet computers, digital cameras, smart bracelets, smart glasses, in-vehicle displays, medical devices, industrial control equipment, touch interactive terminals, etc., which is not limited in the embodiments of the present disclosure.

Note that the above description is merely preferred embodiments of the present disclosure and the technical principles employed. Those skilled in the art will understand that the present disclosure is not limited to the specific embodiments described herein, and various obvious changes, readjustments, combinations, and substitutions can be made without departing from the protection scope of the present disclosure. Therefore, although the present disclosure has been described in detail through the above embodiments, the present disclosure is not limited to the above embodiments, and may include many other equivalent embodiments without departing from the concept of the present disclosure, the scope of which is determined by the scope of the attached claims.

What is claimed is:

1. A display panel, comprising a driving circuit;
wherein the driving circuit comprises shift registers that are cascaded, the shift registers comprise an x-th stage shift register and a y-th stage shift register;
wherein one of the shift registers comprises a first node control module, a second node control module, a pull-down control module, a first pull-down module, a second pull-down module, and an output module;
wherein the first node control module is configured to receive at least an input signal and a clock signal, and to control a signal of a first node;
wherein the second node control module is configured to receive at least the signal of the first node, and to control a signal of a second node;
wherein the pull-down control module is configured to receive at least the signal of the first node, a first control signal, and a second control signal, and to control conducting states of the first pull-down module and the second pull-down module;
wherein the first pull-down module and the second pull-down module are each configured to pull down the signal of the second node when in a conducting state, and a conducting duration of the first pull-down module does not overlap with a conducting duration of the second pull-down module;
wherein the output module is configured to receive at least the signal of the first node and the signal of the second node, and to output a gate driving signal; and
wherein a gate driving signal output by the x-th stage shift register is an input signal of the y-th stage shift register, where x≠y, and x and y are positive integers.

2. The display panel according to claim 1, wherein
the pull-down control module comprises a first pull-down control sub-module and a second pull-down control sub-module;
the first pull-down control sub-module is configured to receive at least the first control signal and the signal of the first node, and to control the conducting state of the first pull-down module; and
the second pull-down control sub-module is configured to receive at least the second control signal and the signal of the first node, and to control the conducting state of the second pull-down module.

3. The display panel according to claim 2, wherein
the first pull-down control sub-module comprises a first turn-on control unit and a first turn-off control unit;
the first turn-on control unit is configured to provide the first control signal to the first pull-down module when the signal of the first node is at a level that controls the first pull-down module to be turned on;
the first turn-off control unit is configured to provide a first level signal to the first pull-down module when the signal of the first node is at a level that controls the first pull-down module to be turned off; and
wherein the first control signal comprises a first control signal valid level and a first control signal invalid level, the first control signal valid level is configured to control the first pull-down module to be turned on, and the first control signal invalid level and the first level signal are configured to control the first pull-down module to be turned off.

4. The display panel according to claim 3, wherein
the first turn-on control unit comprises a first transistor, and the first turn-off control unit comprises a second transistor;
a gate of the first transistor and a gate of the second transistor are electrically connected to the first node, a first electrode of the first transistor receives the first control signal, a first electrode of the second transistor receives the first level signal, and a second electrode of the first transistor and a second electrode of the second transistor are electrically connected to a third node; and
wherein the first pull-down module is electrically connected to the third node, and a channel type of the first transistor is different from a channel type of the second transistor.

5. The display panel according to claim 3, wherein
the first turn-on control unit comprises a first transistor, and the first turn-off control unit comprises a second transistor;
a gate of the first transistor is electrically connected to the first node, and a first electrode of the first transistor receives the first control signal;
a gate of the second transistor is electrically connected to a first electrode of the second transistor, the first electrode of the second transistor receives the first level signal, and a second electrode of the second transistor and a second electrode of the first transistor are electrically connected to a third node; and
wherein the first pull-down module is electrically connected to the third node.

6. The display panel according to claim 3, wherein
the first turn-on control unit comprises a first transistor, and the first turn-off control unit comprises a second transistor;
a gate of the first transistor is electrically connected to a first electrode of the first transistor, and the first electrode of the first transistor receives the first control signal;
a gate of the second transistor is electrically connected to the first node, a first electrode of the second transistor receives the first level signal, and a second electrode of the second transistor and a second electrode of the first transistor are electrically connected to a third node; and
wherein the first pull-down module is electrically connected to the third node.

7. The display panel according to claim 5, wherein a channel type of the first transistor is different from a channel type of the second transistor.

8. The display panel according to claim 5, wherein
the first transistor is an N-type transistor, and the second transistor is a P-type transistor; and
a channel width-to-length ratio of the first transistor is greater than a channel width-to-length ratio of the second transistor.

9. The display panel according to claim 6, wherein
the first transistor is an N-type transistor, and the second transistor is a P-type transistor; and
a channel width-to-length ratio of the first transistor is smaller than a channel width-to-length ratio of the second transistor.

10. The display panel according to claim 2, wherein
the second pull-down control sub-module comprises a second turn-on control unit and a second turn-off control unit;
the second turn-on control unit is configured to provide the second control signal to the second pull-down module when the signal of the first node is at a level that controls the second pull-down module to be turned on;
the second turn-off control unit is configured to provide a first level signal to the second pull-down module when the signal of the first node is at a level that controls the second pull-down module to be turned off; and
wherein the second control signal comprises a second control signal valid level and a second control signal invalid level, the second control signal valid level is configured to control the second pull-down module to be turned on, and the second control signal invalid level and the first level signal are configured to control the second pull-down module to be turned off.

11. The display panel according to claim 10, wherein
the second turn-on control unit comprises a third transistor, and the second turn-off control unit comprises a fourth transistor;
a gate of the third transistor and a gate of the fourth transistor are electrically connected to the first node, a first electrode of the third transistor receives the second control signal, a first electrode of the fourth transistor receives the first level signal, and a second electrode of the third transistor and a second electrode of the fourth transistor are electrically connected to a fourth node; and
wherein the second pull-down module is electrically connected to the fourth node, and a channel type of the third transistor is different from a channel type of the fourth transistor.

12. The display panel according to claim 10, wherein
the second turn-on control unit comprises a third transistor, and the second turn-off control unit comprises a fourth transistor,
a gate of the third transistor is electrically connected to the first node, and a first electrode of the third transistor receives the second control signal;
a gate of the fourth transistor is electrically connected to a first electrode of the fourth transistor, the first electrode of the fourth transistor receives the first level signal, and a second electrode of the fourth transistor and a second electrode of the third transistor are electrically connected to a fourth node; and
wherein the second pull-down module is electrically connected to the fourth node.

13. The display panel according to claim 10, wherein
the second turn-on control unit comprises a third transistor, and the second turn-off control unit comprises a fourth transistor;
a gate of the third transistor is electrically connected to a first electrode of the third transistor, and the first electrode of the third transistor receives the second control signal;
a gate of the fourth transistor is electrically connected to the first node, a first electrode of the fourth transistor receives the first level signal, and a second electrode of the fourth transistor and a second electrode of the third transistor are electrically connected to a fourth node; and
wherein the second pull-down module is electrically connected to the fourth node.

14. The display panel according to claim 12, wherein a type of the third transistor is different from a type of the fourth transistor.

15. The display panel according to claim 12, wherein
the third transistor is an N-type transistor, and the fourth transistor is a P-type transistor; and
a channel width-to-length ratio of the third transistor is greater than a channel width-to-length ratio of the fourth transistor.

16. The display panel according to claim 13, wherein
the third transistor is an N-type transistor, and the fourth transistor is a P-type transistor, and
a channel width-to-length ratio of the third transistor is smaller than a channel width-to-length ratio of the fourth transistor.

17. The display panel according to claim 1, wherein
the first pull-down module comprises a first pull-down transistor, a gate of the first pull-down transistor is electrically connected to the pull-down control module, a first electrode of the first pull-down transistor receives a first level signal, and a second electrode of the first pull-down transistor is electrically connected to the second node; and/or
the second pull-down module comprises a second pull-down transistor, a gate of the second pull-down transistor is electrically connected to the pull-down control module, a first electrode of the second pull-down transistor receives a first level signal, and a second electrode of the second pull-down transistor is electrically connected to the second node.

18. The display panel according to claim 1, wherein
the first node control module comprises a first node control transistor, a gate of the first node control transistor receives the clock signal, a first electrode of the first node control transistor receives the input signal, and a second electrode of the first node control transistor is electrically connected to the first node; and/or
the second node control module comprises a second node control transistor, a gate of the second node control transistor is electrically connected to the first node, a first electrode of the second node control transistor receives a second level signal, and a second electrode of the second node control transistor is electrically connected to the second node.

19. The display panel according to claim 1, wherein
the output module comprises a first output transistor and a second output transistor;
a gate of the first output transistor is electrically connected to the first node, a first electrode of the first output transistor receives a first level signal, and a second electrode of the first output transistor is configured to output the gate driving signal; and
a gate of the second output transistor is electrically connected to the second node, a first electrode of the second output transistor receives a second level signal, and a second electrode of the second output transistor is configured to output the gate driving signal.

20. A display apparatus, comprising a display panel, wherein the display panel comprises a driving circuit,
wherein the driving circuit comprises shift registers that are cascaded, the shift registers comprise an x-th stage shift register and a y-th stage shift register;
wherein one of the shift registers comprises a first node control module, a second node control module, a pull-down control module, a first pull-down module, a second pull-down module, and an output module;
wherein the first node control module is configured to receive at least an input signal and a clock signal, and to control a signal of a first node;
wherein the second node control module is configured to receive at least the signal of the first node, and to control a signal of a second node;
wherein the pull-down control module is configured to receive at least the signal of the first node, a first control signal, and a second control signal, and to control conducting states of the first pull-down module and the second pull-down module;
wherein the first pull-down module and the second pull-down module are each configured to pull down the signal of the second node when in a conducting state, and a conducting duration of the first pull-down module does not overlap with a conducting duration of the second pull-down module;
wherein the output module is configured to receive at least the signal of the first node and the signal of the second node, and to output a gate driving signal; and
wherein a gate driving signal output by the x-th stage shift register is an input signal of the y-th stage shift register, where x≠y, and x and y are positive integers.
